(19) United States
(12) Patent Application Publication
(10) Pub. No.: US 2024/0201607 A1
(43) Pub. Date: Jun. 20, 2024

(54) ELECTROPHOTOGRAPHIC PHOTOSENSITIVE MEMBER, PROCESS CARTRIDGE, AND IMAGE FORMING APPARATUS

(71) Applicant: KYOCERA Document Solutions Inc., Osaka (JP)

(72) Inventors: Tomofumi SHIMIZU, Osaka (JP); Makoto SHISHIDO, Osaka (JP)

(73) Assignee: KYOCERA Document Solutions Inc., Osaka (JP)

(21) Appl. No.: 18/518,404

(22) Filed: Nov. 22, 2023

(30) Foreign Application Priority Data
Nov. 25, 2022 (JP) 2022-188527

(51) Int. Cl. G03G 5/05; G03G 5/06; G03G 15/00

(52) U.S. Cl. CPC G03G 5/056; G03G 5/0609; G03G 5/0618; G03G 5/0672; G03G 15/75

(57) ABSTRACT

A photosensitive layer being a single layer of an electrophotographic photosensitive member contains a charge generating material, a binder resin, an electron transport material, and a hole transport material. The binder resin includes a polyarylate resin. The polyarylate resin includes repeating units represented by formulas (1), (2), (3), and (4).

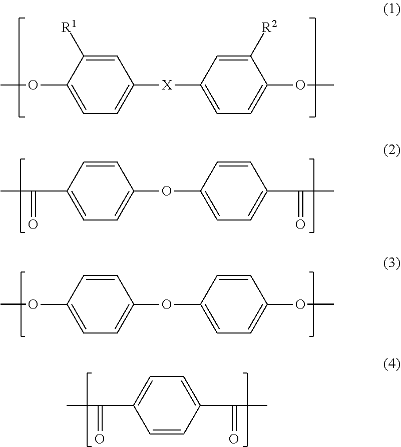

The repeating unit (3) has a percentage content of greater than 0% and less than 50% to a total number of repeats of the repeating units (1) and (3). The repeating unit (4) has a percentage content of at least 35% and less than 70% to a total number of repeats of the repeating units (2) and (4).

### INCORPORATION BY REFERENCE

The present application claims priority under 35 U.S.C. § 119 to Japanese Patent Application No. 2022-188527, filed on Nov. 25, 2022. The contents of this application are incorporated herein by reference in their entirety.

### BACKGROUND

The present disclosure relates to an electrophotographic photosensitive member, a process cartridge, and an image forming apparatus.

Electrophotographic photosensitive members are used as image bearing members in electrographic image forming apparatuses (e.g., printers and multifunction peripherals). There are various studies on improving the mechanical strength of electrophotographic photoreceptors. As one example of the electrophotographic photosensitive members, there is proposed an electrophotographic photosensitive member including a surface layer containing a polyarylate resin obtained from a dihydric phenol component and a dibasic carboxylic acid component represented by the following formula.

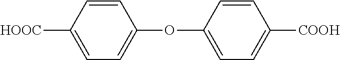 [SMILES: O=C(O)c1ccc(Oc2ccc(C(=O)O)cc2)cc1]

### SUMMARY

According to an aspect of the present disclosure, an electrophotographic photosensitive member includes a conductive substrate and a photosensitive layer. The photosensitive layer is a single layer. The photosensitive layer contains a charge generating material, a binder resin, an electron transport material, and a hole transport material. The binder resin includes a polyarylate resin. The polyarylate resin includes repeating units represented by formulas (1), (2), (3), and (4). The repeating unit represented by the formula (3) has a percentage content of greater than 0% and less than 50% to a total number of repeats of the repeating units represented by the formulas (1) and (3). The repeating unit represented by the formula (4) has a percentage content of at least 35% and less than 70% to a total number of repeats of the repeating units represented by the formulas (2) and (4). The electron transport material includes a compound represented by formula (11), (12), (13), (14), (15), (16) or (17). The hole transport material includes a compound represented by formula (20), (21), or (22). The electron transport material has a percentage content of at least 15% by mass and no greater than 35% by mass to the mass of the photosensitive layer.

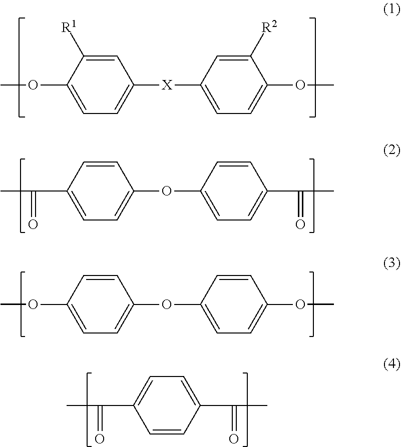

In the formula (1), R¹ and R² each represent a methyl group and X represents a divalent group represented by formula (X1). Alternatively, R¹ and R² each represent a hydrogen atom and X represents a divalent group represented by formula (X2).

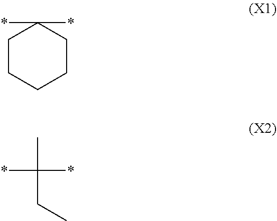

In the formulas (X1) and (X2), * represents a bond.

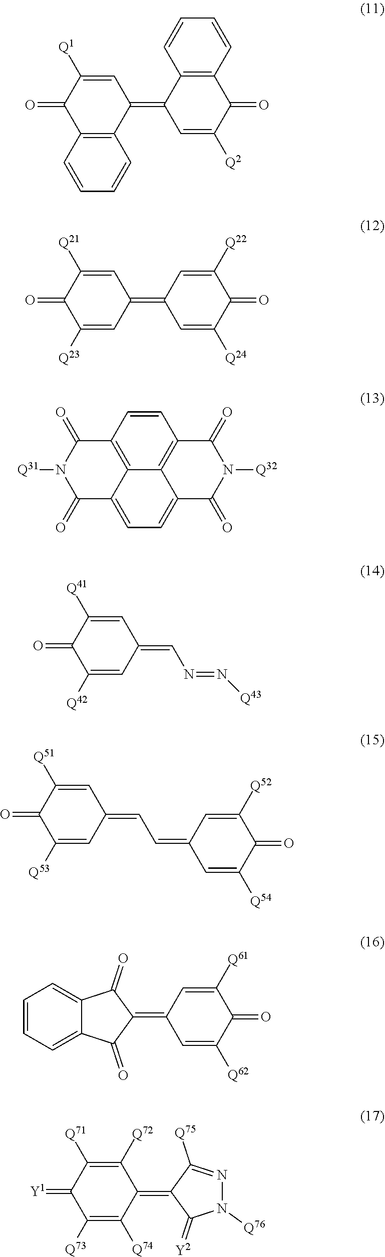

Q¹ and Q² in the formula (11), Q²¹, Q²², Q²³, and Q²⁴ in the formula (12), Q³¹ and Q³² in the formula (13), Q⁴¹, Q⁴², and Q⁴³ in the formula (14), Q⁵¹, Q⁵², Q⁵³, and Q⁵⁴ in the formula (15), Q⁶¹ and Q⁶² in the formula (16), and Q⁷¹, Q⁷², Q⁷³, Q⁷⁴, Q⁷⁵, and Q⁷⁶ in the formula (17) each represent, independently of one another, a hydrogen atom, a halogen atom, a cyano group, an alkyl group with a carbon number of at least 1 and no greater than 6, an alkenyl group with a carbon number of at least 2 and no greater than 6, an alkoxy group with a carbon number of at least 1 and no greater than 6, or an aryl group with a carbon number of at least 6 and no greater than 14 optionally substituted with at least one substituent selected from the group consisting of a halogen atom and an alkyl group with a carbon number of at least 1 and no greater than 6. In the formula (17), Y¹ and Y² each represent, independently of one another, an oxygen atom or a sulfur atom.

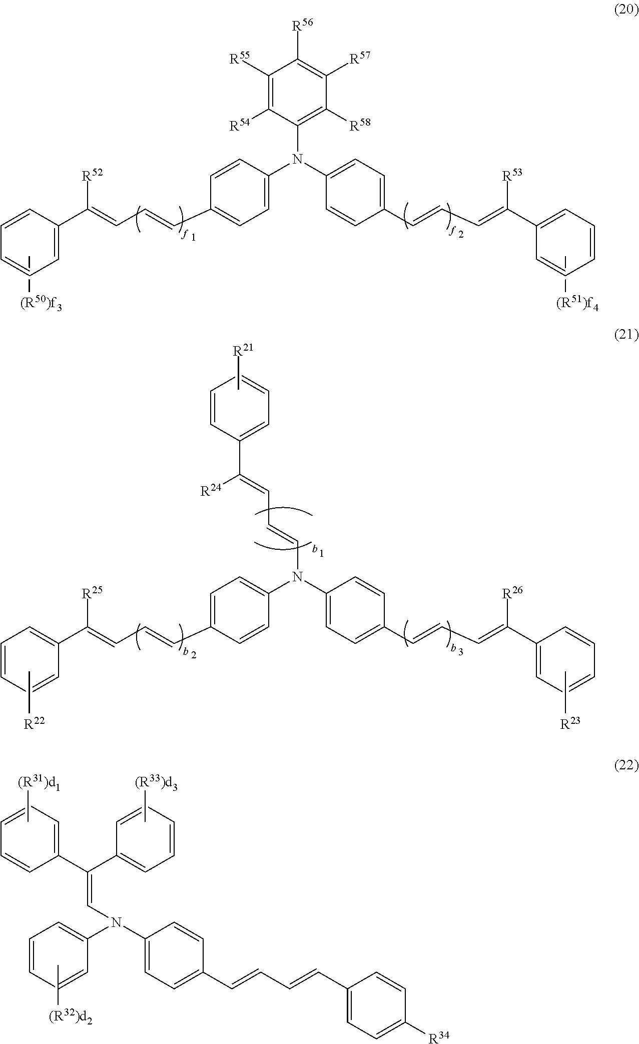

In the formula (20), R⁵⁰ and R⁵¹ each represent, independently of one another, a phenyl group, an alkyl group with carbon number of at least 1 and no greater than 6, or an alkoxy group with carbon number of at least 1 and no greater than 6. R⁵², R⁵³, R⁵⁴, R⁵⁵, R⁵⁶, R⁵⁷, and R⁵⁸ each represent, independently of one another, a hydrogen atom, an alkyl group with carbon number of at least 1 and no greater than 6, an alkoxy group with carbon number of at least 1 and no greater than 6, or a phenyl group optionally substituted with an alkyl group with carbon number of at least 1 and no greater than 6. f₁ and f₂ each represent, independently of one another, an integer of at least 0 and no greater than 2. f₃ and f₄ each represent, independently of one another, an integer of at least 0 and no greater than 5. In the formula (21), R²¹, R²², and R²³ each represent, independently of one another, an alkyl group with carbon number of at least 1 and no greater than 6. R²⁴, R²⁵, and R²⁶ each represent, independently of one another, a hydrogen atom or an alkyl group with carbon number of at least 1 and no greater than 6. b₁, b₂, and b₃ each represent, independently of one another, 0 or 1. In the formula (22), R³¹, R³², and R³³ each represent, independently of one another, an alkyl group with carbon number of at least 1 and no greater than 6 and R³⁴ represents a hydrogen atom or an alkyl group with carbon number of at least 1 and no greater than 6. d₁, d₂, and d₃ each represent, independently of one another, an integer of at least 0 and no greater than 5.

According to another aspect of the present disclosure, a process cartridge includes the aforementioned electrophotographic photosensitive member and at least one selected from the group consisting of a charger, a light exposure device, a development device, a transfer device, a cleaner, and a static eliminator.

According to still another aspect of the present disclosure, an image forming apparatus includes an image bearing member, a charger that charges a surface of the image bearing member, a light exposure device that irradiates the charged surface of the image bearing member with light to form an electrostatic latent image on the surface of the image bearing member, a development device that develops the electrostatic latent image into a toner image by supplying a toner to the surface of the image bearing member, and a transfer device that transfers the toner image from the image bearing member to a transfer target. The image bearing member is the aforementioned electrophotographic photosensitive member.

### BRIEF DESCRIPTION OF THE DRAWINGS

FIG. 1 is a partial cross-sectional view of an example of an electrophotographic photosensitive member according to a first embodiment of the present disclosure.

FIG. 2 is a partial cross-sectional view of an example of the electrophotographic photosensitive member according to the first embodiment of the present disclosure.

FIG. 3 is a partial cross-sectional view of an example of the electrophotographic photosensitive member according to the first embodiment of the present disclosure.

FIG. 4 is a diagram illustrating an example of an image forming apparatus according to a second embodiment of the present disclosure.

FIG. 5 is a diagram illustrating an example of the configuration of a development device illustrated in FIG. 4.

FIG. 6 is a ¹H-NMR spectrum of a polyarylate resin (R-1).

### DETAILED DESCRIPTION

The following describes embodiments of the present disclosure. However, the present disclosure is not limited to the following embodiments and can be practiced with alterations made as appropriate within a scope of objects of the present disclosure. Values for viscosity average molecular weight are values as measured in accordance with “the Japanese Industrial Standards (JIS) K7252-1:2016 unless otherwise stated. The term “-based” may be appended to the name of a chemical compound to form a generic name encompassing both the chemical compound itself and derivatives thereof. Also, when the term “-based” is appended to the name of a chemical compound used in the name of a polymer, the term indicates that a repeating unit of the polymer originates from the chemical compound or a derivative thereof. The phrase “each represent, independently of one another,” in description about formulas means possibly representing the same group or different groups. One type of each component described in the present specification may be used independently, or two or more types of the component may be used in combination unless otherwise stated.

The terms used in the present specification have been explained so far.

### First Embodiment: Electrophotographic Photosensitive Member

The following describes an electrophotographic photosensitive member (also referred to below as a photosensitive member) according to a first embodiment of the present disclosure. The photosensitive member of the first embodiment includes a conductive substrate and a photosensitive layer. The photosensitive layer is a single layer. That is, the photosensitive member of the first embodiment is a single-layer electrophotographic photosensitive member including a single-layer photosensitive layer.

With reference to FIGS. 1 to 3, a photosensitive member 1 is described that is an example of the photosensitive member of the first embodiment. FIGS. 1 to 3 each are a partial cross-sectional view of an example of the photosensitive member 1.

As illustrated in FIG. 1, the photosensitive member 1 includes a conductive substrate 2 and a photosensitive layer 3, for example. The photosensitive layer 3 is a single layer (one layer).

As illustrated in FIG. 2, the photosensitive member 1 may further include an intermediate layer 4 (undercoat layer) in addition to the conductive substrate 2 and the photosensitive layer 3. The intermediate layer 4 is provided between the conductive substrate 2 and the photosensitive layer 3. As illustrated in FIG. 1, the photosensitive layer 3 may be provided directly on the conductive substrate 2. Alternatively, the photosensitive layer 3 may be provided on the conductive substrate 2 with the intermediate layer 4 therebetween as illustrated in FIG. 2.

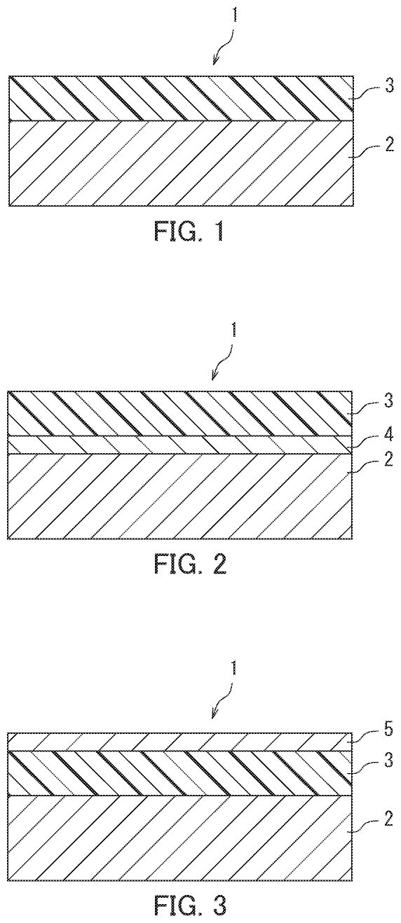

As illustrated in FIG. 3, the photosensitive member 1 may further include a protective layer 5 in addition to the conductive substrate 2 and the photosensitive layer 3. The protective layer 5 is provided on the photosensitive layer 3, for example. However, it is preferable that the photosensitive member 1 does not include the protective layer 5 as illustrated in FIGS. 1 and 2. Furthermore, the photosensitive layer 3 is preferably provided as an outermost surface layer of the photosensitive member 1. As a result of the photosensitive layer 3 that contains a later-described polyarylate resin (PA) being provided as the outermost surface layer, the photosensitive member 1 can have further increased abrasion resistance, filming resistance, and scratch resistance.

No particular limitations are placed on the thickness of the photosensitive layer 3 and the thickness of the photosensitive layer 3 is preferably as least 5 μm and no greater than 100 μm, and more preferably at least 10 μm and no greater than 50 μm. The photosensitive member 1 has been described so far with reference to FIGS. 1 to 3. The photosensitive member is described below further in detail.

The photosensitive layer contains a charge generating material, a binder resin, an electron transport material, and a hole transport material. The photosensitive layer may further contain a later-described specific additive and an additional additive other than the specific additive as necessary. Description is made below of the charge generating material, the binder resin, the electron transport material, the hole transport material, the specific additive, and the additional additive.

### <Charge Generating Material>

Examples of the charge generating material include phthalocyanine-based pigments, perylene-based pigments, bisazo pigments, tris-azo pigments, dithioketopyrrolopyrrole pigments, metal-free naphthalocyanine pigments, metal naphthalocyanine pigments, squaraine pigments, indigo pigments, azulenium pigments, cyanine pigments, powders of inorganic photoconductive materials (e.g., selenium, selenium-tellurium, selenium-arsenic, cadmium sulfide, and amorphous silicon), pyrylium pigments, anthanthrone-based pigments, triphenylmethane-based pigments, threne-based pigments, toluidine-based pigments, pyrazoline-based pigments, and quinacridone pigments. The photosensitive layer may contain only one charge generating material or may contain two or more charge generating materials.

The phthalocyanine-based pigments have a phthalocyanine structure. Examples of the phthalocyanine-based pigments include metal phthalocyanines and metal-free phthalocyanine. Examples of metal phthalocyanines include titanyl phthalocyanine, hydroxygallium phthalocyanine, and chlorogallium phthalocyanine. Titanyl phthalocyanine is preferable as a metal phthalocyanine. Titanyl phthalocyanine is represented by formula (CG-1). Metal-free phthalocyanine is presented by formula (CG-2).

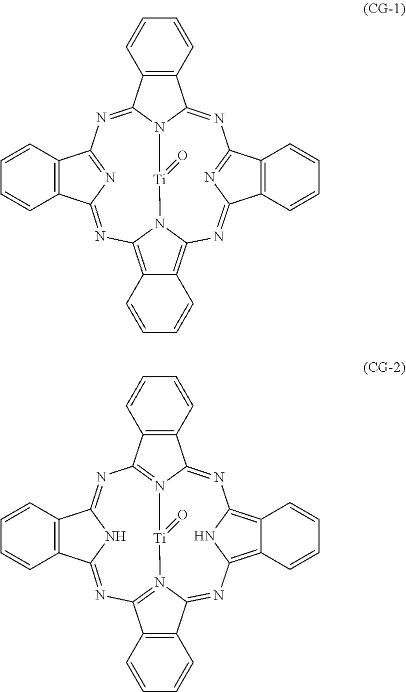

The phthalocyanine-based pigments may be crystalline or non-crystalline. An example of crystalline metal-free phthalocyanine is metal-free phthalocyanine having an X-form crystal structure (also referred to below as X-form metal-free phthalocyanine). Examples of crystalline titanyl phthalocyanine include titanyl phthalocyanine having an C-form crystal structure, titanyl phthalocyanine having a β-form crystal structure, and titanyl phthalocyanine having a Y-form crystal structure (also referred to below as α-form titanyl phthalocyanine. D-form titanyl phthalocyanine, and Y-form titanyl phthalocyanine, respectively).

For example, a photosensitive member having a sensitivity in a wavelength range of at least 700 nm is preferably used in digital optical image forming apparatuses (e.g., laser beam printers and facsimiles using a light source such as a semiconductor laser). In terms of having high quantum yield in a wavelength range of at least 700 nm, the charge generating material is preferably a phthalocyanine-based pigment, more preferably metal-free phthalocyanine or titanyl phthalocyanine, and particularly preferably X-form metal-free phthalocyanine or Y-form titanyl phthalocyanine.

Y-form titanyl phthalocyanine exhibits a main peak for example at a Bragg angle (2θ±0.2°) of 27.2° in a CuKα characteristic X-ray diffraction spectrum. The term main peak refers to a peak that is the most intense or second most intense peak within a range of Bragg angles (2θ±0.2°) between 3° and 40° on a CuKα characteristic X-ray diffraction spectrum. Y-form titanyl phthalocyanine did not exhibit a peak at 26.2° on the CuKα characteristic X-ray diffraction spectrum.

The CuKα characteristic X-ray diffraction spectrum can be plotted by the following method, for example. First, a sample (titanyl phthalocyanine) is loaded into a sample holder of an X-ray diffractometer (e.g., “RINT (registered Japanese trademark) 1100”, product of Rigaku Corporation) and an X-ray diffraction spectrum is plotted under conditions of use of an X-ray tube made from Cu, a tube voltage of 40 kV, a tube current of 30 mA, and a wavelength of the CuKα characteristic X-ray of 1.542 Å. The measurement range (2θ) is for example from 3° to 40° (start angle: 3°, stop angle: 40°), and the scanning speed is for example 10°/min. The main peak is determined from the plotted X-ray diffraction spectrum and the Bragg angle of the main peak is read.

The charge generating material has a content of preferably at least 0.1 parts by mass and no greater than 50 parts by mass relative to 100 parts by mass of the binder resin, and further preferably at least 0.5 parts by mass and no greater than 5 parts by mass.

### <Binder Resin>

The binder resin includes a polyarylate resin. The polyarylate resin includes repeating units represented by formulas (1), (2), (3), and (4). The repeating unit represented by formula (3) has a percentage content of greater than 0% and less than 50% to the total number of repeats of the repeating units represented by formulas (1) and (3). The repeating unit represented by formula (4) has a percentage content of at least 35% and less than 70% to the total number of repeats of the repeating units represented by formulas (2) and (4).

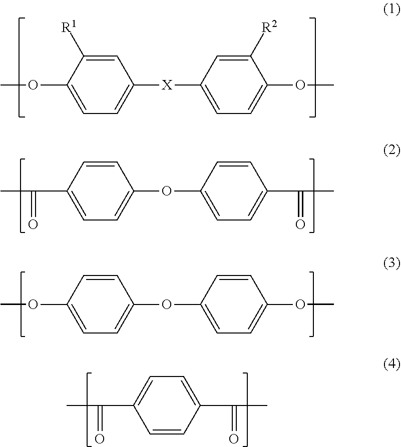

In formula (1), R¹ and R² each represent a methyl group and X represents a divalent group represented by formula (X1). Alternatively, R¹ and R² each represent a hydrogen atom and X represents a divalent group represented by formula (X2).

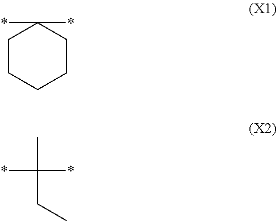

In formulas (X1) and (X2), * represents a bond. The bond represented by * in formulas (X1) and (X2) is bonded to a carbon atom to which X in formula (1) is bonded.

In the following, the “percentage content of the repeating unit represented by formula (3) to the total number of repeats of the repeating units represented by formulas (1) and (3)” may be also referred to below as a “third percentage content”. The “percentage content of the repeating unit represented by formula (4) to the total number of repeats of the repeating units represented by formulas (2) and (4)” may be also referred to below as a “fourth percentage content”. Also, the “percentage content of the repeating unit represented by formula (1) to the total number of repeats of the repeating units represented by formulas (1) and (3)” may be also referred to below as a “first percentage content”. The “percentage content of the repeating unit represented by formula (2) to the total number of repeats of the repeating units represented by formulas (2) and (4)” may be also referred to below as a “second percentage content”. The “repeating units represented by formulas (1), (2), (3), and (4)” may be also referred to below as “repeating units (1), (2), (3), and (4)”, respectively. A “polyarylate resin including the repeating units (1), (2), (3), and (4) with a third percentage content of greater than 0% and less than 50% and a fourth percentage content of at least 35% and less than 70%” may be also referred to below as a “polyarylate resin (PA)”.

As described previously, the binder resin contained in the photosensitive layer essentially includes the polyarylate resin (PA). As a result of the polyarylate resin (PA) including the repeating units (1) and (4), hardness of the photosensitive layer containing the polyarylate resin (PA) tends to increase. As a result of the polyarylate resin (PA) including the repeating units (2) and (2), the elastic modules of the photosensitive layer containing the polyarylate resin (PA) tends to increase. An increase in the hardness and elastic modulus of the photosensitive layer increases the abrasion resistance of the photosensitive member. Moreover, the photosensitive layer containing the polyarylate resin (PA) is scratch resistant. Therefore, filming resistance of the photosensitive member can be improved as toner hardly enters fine scratches. Furthermore, as a result of the photosensitive layer containing the polyarylate resin (PA), scratch resistance of the photosensitive member improves.

Furthermore, an application liquid for photosensitive in which the electron transport material and the hole transport material are uniformly dispersed can be formed because of excellent solubility of the polyarylate resin (PA) in solvents. Accordingly, a photosensitive layer in which the electron transport material and the hole transport material are uniformly dispersed can be favorably formed, facilitating smooth charge transport in the photosensitive layer. Thus, occurrence of transfer memory can be inhibited. Furthermore, due to the excellent solubility of polyarylate resin (PA) in solvents, the photosensitive layer hardly crystallizes even when relatively large amounts of the electron transport material and the hole transport material are present.

Where R¹ and R² each represents a methyl group and X represents a divalent group represented by formula (X1) in formula (1), the repeating unit (1) is a repeating unit (also referred to below as repeating unit (1-1) represented by formula (1-1)). Where R¹ and R² each represent a hydrogen atom and X represents a divalent group represented by formula (X2) in formula (1), the repeating unit (1) is a repeating unit (also referred to below as repeating unit (1-2) represented by formula (1-2)). The polyarylate resin (PA) may include only one repeating unit (1) or may include two or more repeating units (1).

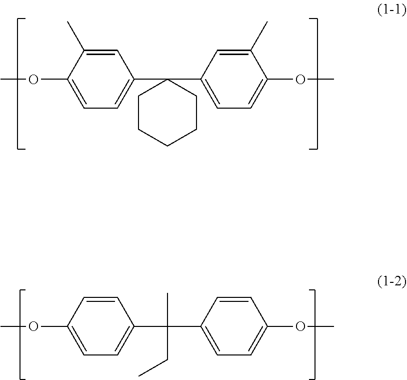

The first percentage content corresponds to a percentage (i.e., 100×M₁/M₁+M₃)) of a number M₁ of repeats of the repeating unit (1) to the total of the number M₁ of repeats of the repeating unit (1) and a number M₃ of repeats of the repeating unit (3) in the polyarylate resin (PA). Where the polyarylate resin (PA) includes two repeating units (1), the number M₁ of repeats of the repeating unit (1) is the total number of repeats of the two repeating units (1). The first percentage content is preferably less than 100%, more preferably no greater than 99%, further preferably no greater than 90%, and even more preferably no greater than 80%. Moreover, the first percentage content is preferably greater than 50%, more preferably at least 60%, and further preferably at least 70%. In order to improve the abrasion resistance of the photosensitive member and inhibit the transfer memory, the first percentage content is preferably at least 60% and less than 100%, and more preferably at least 70% and no greater than 90%.

The second percentage content corresponds to a percentage (i.e., 100×M₂/(M₂+M₄)) of a number M₂ of repeats of the repeating unit (2) to the total of the number M₂ of repeats of the repeating unit (2) and a number M₄ of repeats of the repeating unit (4) in the polyarylate resin (PA).

The second percentage content is preferably no greater than 65%. Moreover, the second percentage content is preferably greater than 30%, more preferably at least 35%, further preferably at least 40%, even more preferably at least 50%, and particularly preferably at least 55%. In order to improve the abrasion resistance of the photosensitive member and inhibit the transfer memory, the second percentage content is preferably at least 35% and no greater than 65%, more preferably at least 50% and no greater than 65%, and further preferably at least 55% and no greater than 65%.

As described previously, the third percentage content is greater than 0% and less than 50%. The third percentage content corresponds to a percentage (i.e., 100×M₃/(M₁+M₃)) of the number M₁ of repeats of the repeating unit (1) to the total of the number M₁ of repeats of the repeating unit (1) and the number M₃ of repeats of the repeating unit (3) in the polyarylate resin (PA).

As a result of the third percentage content being less than 50%, the polyarylate resin (PA) has increased solubility in solvents, thereby enabling favorable formation of the photosensitive layer. Improvements in abrasion resistance, filming resistance and scratch resistance of the photosensitive member can be achieved, and transfer memory can be suppressed when the third percentage content is greater than 0%, i.e. when the third percentage content is not 0%.

In order to improve abrasion resistance, filming resistance, and scratch resistance of the photosensitive member and inhibit the transfer memory, the third percentage content is preferably at least 1%, and more preferably at least 10%. In order to improve abrasion resistance of the photosensitive member and inhibit transfer memory, the third percentage content is preferably no greater than 49%, more preferably no greater than 45%, further preferably no greater than 40%, further more preferably no greater than 35%, even further more preferably no greater than 30%, and particularly preferably no greater than 20%. In order to improve abrasion resistance of the photosensitive member and inhibit transfer memory, the third percentage content is preferably at least 10% and no greater than 40%, and more preferably at least 10% and no greater than 30%.

As described previously, the fourth percentage content is at least 35% and less than 70%. The fourth percentage content corresponds to a percentage (i.e., 100×M₄/(M₂+M₄)) of the number M₄ of repeats of the repeating unit (4) to the total of the number M₂ of repeats of the repeating unit (2) and the number M₄ of repeats of the repeating unit (4) in the polyarylate resin (PA).

As a result of the fourth percentage content being at least 35%, abrasion resistance, filming resistance, and scratch resistance of the photosensitive member are improved. Improvement of solubility of the polyarylate resin (PA) in solvents can be achieved as the fourth percentage content is at least 35%, which enables preferable formation of a photosensitive layer. As a result of the fourth percentage content being less than 70% by contrast, abrasion resistance, filming resistance, and scratch resistance of the photosensitive member are improved and transfer memory is inhibited. The fourth percentage content is preferably no greater than 69%, more preferably no greater than 65%, further preferably no greater than 60%, even more preferably no greater than 50%, and particularly preferably no greater than 45%. In order to improve filming resistance and scratching resistance while further improving abrasion resistance thereof and further inhibiting transfer memory, the fourth percentage content is preferably at least 35% and no greater than 65%, more preferably at least 35% and no greater than 50%, and further preferably at least 35% and no greater than 45%.

Each of the first percentage content, the second percentage content, the third percentage content, and the fourth percentage content can be calculated from rates of peaks unique to the respective repeating units on a ¹H-NMR spectrum of the polyarylate resin (PA) plotted using a proton nuclear magnetic resonance spectrometer.

In order to increase solubility in solvents and improve abrasion resistance, filming resistance, and scratch resistance of the photosensitive member, the first percentage content is preferably a value different from the second percentage content and the fourth percentage content. For the same purpose as above, the third percentage content is preferably a value different from the second percentage content and the fourth percentage content.

In order to further improve filming resistance and scratch resistance of the photosensitive member, it is preferable in formula (1) that R¹ and R² each represent a methyl group and X represents a divalent group represented by formula (X1).

In order to improve filming resistance and scratch resistance of the photosensitive member while further inhibiting transfer memory, it is preferable that: R¹ and R² each represent a methyl group and X represents a divalent group represented by formula (X1) in formula (1); the third percentage content is at least 10% and no greater than 40%; and the fourth percentage content is at least 35% and no greater than 50%.

In order to increase filming resistance and scratch resistance of the photosensitive member while further improving abrasion resistance thereof and inhibiting transfer memory, it is preferable that: R¹ and R² each represent a methyl group and X represents a divalent group represented by formula (X1) in formula (1); the third percentage content is at least 10% and no greater than 30%; and the fourth percentage content is at least 35% and no greater than 45%.

In order to improve filming resistance and scratch resistance of the photosensitive member while further improving sensitivity characteristics thereof, it is preferable that the polyarylate resin (PA) does not include a repeating unit having a biphenyl structure. An example of the repeating unit having a biphenyl structure is a repeating unit represented by formula (5). Examples of the repeating unit represented by formula (5) include repeating units represented by formulas (5-1) and (5-2).

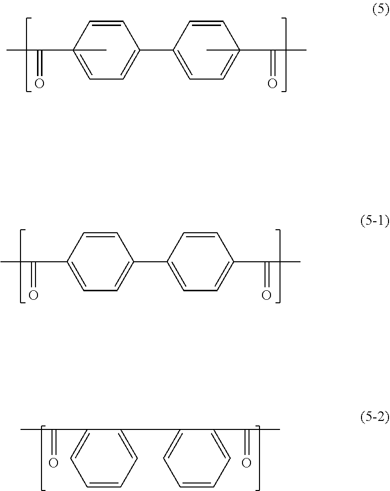

In order to improve filming resistance and scratch resistance of the photosensitive member, it is preferable that the polyarylate resin (PA) does not include a repeating unit derived from isophthalic acid.

The polyarylate resin (PA) has an end group, for example. Examples of the end group of the polyarylate resin (PA) include end groups represented by formulas (T-1) and (T-2) (also referred to below as end groups (T-1) and (T-2), respectively). The end group (T-1) is preferably an end group represented by formula (T-DMP) (also referred to below as an end group (T-DMP)). The end group (T-2) is preferably an end group represented by formula (T-PFH) (also referred to below as an end group (T-PFH)).

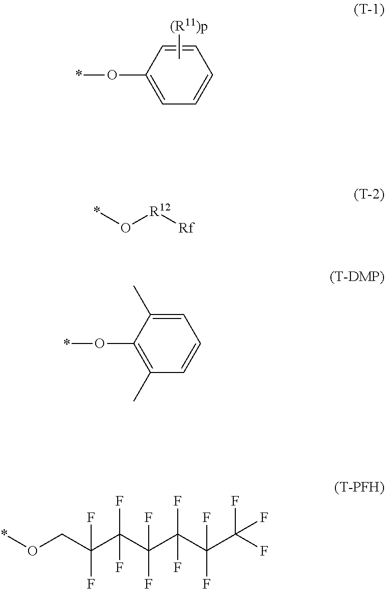

In formula (T-1). R¹¹ represents a halogen atom or an alkyl group with a carbon number of at least 1 and no greater than 6 and p represents an integer of at least 0 and no greater than 5. R¹¹ preferably represents an alkyl group with a carbon number of at least 1 and no greater than 6, more preferably represents an alkyl group with a carbon number of at least 1 and no greater than 3, and further preferably represents a methyl group, p preferably represents an integer of at least 1 and no greater than 3, and more preferably represents 2.

In formula (T-2), R¹² represents an alkanediyl group with a carbon number of at least 1 and no greater than 6 and Rf represents a perfluoroalkyl group with a carbon number of at least 1 and no greater than 10. R¹² preferably represents an alkanediyl group with a carbon number of at least 1 and no greater than 3, and more preferably represents a methylene group. Rf preferably represents a perfluoroalkyl group with a carbon number of at least 3 and no greater than 10, more preferably represents a perfluoroalkyl group with a carbon number of at least 5 and no greater than 7, and further preferably represents a perfluoroalkyl group with a carbon number of 6.

In formulas (T-1), (T-2), (T-DMP), and (T-PFH), * represents a bond. The bond represented by * in formulas (T-1), (T-2), (T-DMP), and (T-PFH) is bonded to a repeating unit (specifically, the repeating unit (2) or (4)) derived from dicarboxylic acid and located at an end of the polyarylate resin (PA).

In order to improve abrasion resistance of the photosensitive member, the end group is preferably an end group having a halogen atom, more preferably the end group (T-2), and further preferably the end group (T-PFH).

Preferable examples of the polyarylate resin (PA) include polyarylate resins (PA-1) and (PA-2) listed in Table 1. The polyarylate resins (PA-1) and (PA-2) each include repeating units listed in Table 1 as the repeating units (1) to (4). Further preferable examples of the polyarylate resin (PA) include polyarylate resins (PA-a) to (PA-d) listed in Table 2. The polyarylate resins (PA-a) to (PA-d) each include the repeating units listed in Table 2 as the repeating units (1) to (4) and the end group listed in Table 2. In Tables 1 and 2, the “Unit (1) to Unite (4)” indicate the “repeating units (1) to (4)”, respectively.

TABLE 1

| Polyarylate resin | Unit (1) | Unit (2) | Unit (3) | Unit (4) |
|---|---|---|---|---|
| PA-1 | 1-1 | 2 | 3 | 4 |
| PA-2 | 1-2 | 2 | 3 | 4 |

TABLE 2

| Polyarylate resin | Unit (1) | Unit (2) | Unit (3) | Unit (4) | End group |
|---|---|---|---|---|---|
| PA-a | 1-1 | 2 | 3 | 4 | T-DMP |
| PA-b | 1-2 | 2 | 3 | 4 | T-DMP |
| PA-c | 1-1 | 2 | 3 | 4 | T-PFH |
| PA-d | 1-2 | 2 | 3 | 4 | T-PFH |

In the polyarylate resin (PA), a repeating unit (specifically, the repeating unit (1) or (3)) derived from a bisphenol and a repeating unit (specifically, the repeating unit (2) or (4)) derived from a dicarboxylic acid are adjacent and bonded to each other. That is, the repeating unit (1) may be bonded to the repeating unit (2) or bonded to the repeating unit (4). Also, the repeating unit (3) may be bonded to the repeating unit (2) or bonded to the repeating unit (4). The polyarylate resin (PA) may be a random copolymer, an alternating copolymer, a periodic copolymer, or a block copolymer, for example.

The polyarylate resin (PA) may include only the repeating units (1) to (4) as repeating units or may further include a repeating unit other than the repeating units (1) to (4). In order to increase solubility in solvents and improve abrasion resistance, filming resistance, and scratch resistance of the photosensitive member, the percentage content of the repeating units (1) to (4) in the total number of repeats of the repeating units included in the polyarylate resin (PA) is preferably at least 80%, more preferably at least 90%, further preferably at least 95%, and further more preferably at least 99%, and particularly preferably 100%.

The polyarylate resin (PA) has a viscosity average molecular weight of preferably at least 10,000, more preferably at least 30,000, further preferably at least 35,000, and further more preferably at least 50,000. As a result of the polyarylate resin (PA) having a viscosity average molecular weight of at least 10,000, abrasion resistance, filming resistance, and scratch resistance of the photosensitive member increases. By contrast, the viscosity average molecular weight of the polyarylate resin (PA) is preferably no greater than 80,000, and more preferably no greater than 70,000. As a result of the polyarylate resin (PA) having a viscosity average molecular weight of no greater than 80,000, solubility of the polyarylate resin (PA) in a solvent for photosensitive layer formation increases.

Next, a method for producing the polyarylate resin (PA) is described. An example of the method for producing the polyarylate resin (PA) is condensation polymerization of bisphenols for constituting the repeating units derived from bisphenols and dicarboxylic acids for constituting the repeating units derived from dicarboxylic acids. Condensation polymerization may be any known synthesis method (e.g., solution polymerization, melt polymerization, or interface polymerization).

Examples of bisphenols for constituting the repeating units derived from the bisphenols include compounds represented by formulas (BP-1) and (BP-3) (also referred to below as compounds (BP-1) and (BP-3), respectively). >Examples of dicarboxylic acids for constituting the repeating units derived from the dicarboxylic acids include compounds represented by formulas (DC-2) and (DC-4) (also referred to below as compounds (DC-2) and (DC-4), respectively). R¹, R², and X in formula (BP-1) are respectively the same as those defined for R¹, R², and X in formula (1).

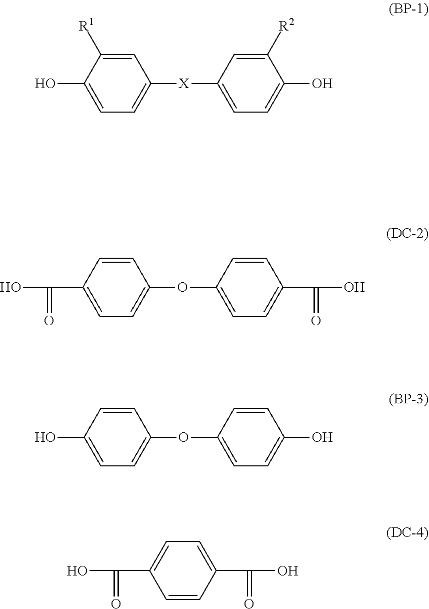

In production of the polyarylate resin (PA), the first percentage content is adjusted by changing the amount (unit: mol) of the compound (BP-1) added to the total (unit: mol) of the amounts of the compounds (BP-1) and (BP-3) added. The first percentage content corresponds to the mole fraction (unit: mol %) of the repeating unit (1) in the total amount of the repeating units (1) and (3) in the polyarylate resin (PA).

In production of the polyarylate resin (PA), the second percentage content is adjusted by changing the amount (unit: mol) of the compound (DC-2) added to the total (unit: mol) of the amounts of the compounds (DC-2) and (DC-4) added. The second percentage content corresponds to the mole fraction (unit: mol %) of the repeating unit (2) in the total amount of the repeating units (2) and (4) in the polyarylate resin (PA).

In production of the polyarylate resin (PA), the third percentage content is adjusted by changing the amount (unit: mol) of the compound (BP-3) added to the total (unit: mol) of the amounts of the compounds (BP-1) and (BP-3) added. The third percentage content corresponds to the mole fraction (unit: mol %) of the repeating unit (3) in the total amount of the repeating units (1) and (3) in the polyarylate resin (PA).

In production of the polyarylate resin (PA), the fourth percentage content is adjusted by changing the amount (unit: mol) of the compound (DC-4) added to the total (unit: mol) of the amounts of the compounds (DC-2) and (DC-4) added. The fourth percentage content corresponds to the mole fraction (unit: mol %) of the repeating unit (4) in the total amount of the repeating units (2) and (4) in the polyarylate resin (PA).

The bisphenols may be derivatized to aromatic diacetates for use. The dicarboxylic acids may be derivatized for use. Examples of derivatives of the dicarboxylic acids include dicarboxylic acid dichloride, dicarboxylic acid dimethyl ester, dicarboxylic acid diethyl ester, and dicarboxylic acid anhydride. Dicarboxylic acid dichloride is a compound in which two “—C(═O)—OH” groups of dicarboxylic acid have each been substituted with a “—C(═O)—Cl” group.

In condensation polymerization of the bisphenols and the dicarboxylic acids, a terminator may be added. Examples of the terminator include 2,6-dimethylphenol and 1H,1H-perfluoro-1-heptanol. Use of 2,6-dimethylphenol as a terminator forms the end group (T-DMP). Use of 1H,1H-perfluoro-1-heptanol as a terminator forms the end group (T-PFH).

In condensation polymerization of the bisphenols and the dicarboxylic acids, either or both a base and a catalyst may be added. An example of the base is sodium hydroxide. Examples of the catalyst include benzyltributylammonium chloride, ammonium chloride, ammonium bromide, quaternary ammonium salt, triethylamine, and trimethylamine.

The photosensitive layer may contain only one polyarylate resin (PA) as the binder resin or may contain two or more polyarylate resins (PA). The photosensitive layer may contain only the polyarylate resin (PA) as the binder resin or may contain a binder resin (also referred to below as an additional binder resin) other than the polyarylate resin (PA). The polyarylate resin (PA) has a percentage content in the binder resin of preferably at least 80% by mass, more preferably at least 90% by mass, further preferably 95% by mass, and particularly preferably 100% by mass.

Examples of the additional binder resin include thermoplastic resins (specific examples include polyarylate resins other than the polyarylate resin (PA), polycarbonate resins, styrene-based resins, styrene-butadiene copolymers, styrene-acrylonitrile copolymers, styrene-maleic acid copolymers, styrene-acrylic acid copolymers, acrylic copolymers, polyethylene resins, ethylene-vinyl acetate copolymers, chlorinated polyethylene resins, polyvinyl chloride resins, polypropylene resins, ionomers, vinyl chloride-vinyl acetate copolymers, polyester resins, alkyd resins, polyamide resins, polyurethane resins, polysulfone resins, diallyl phthalate resins, ketone resins, polyvinyl butyral resins, polyvinyl acetal resins, and polyether resins), thermosetting resins (specific examples include silicone resins, epoxy resins, phenolic resins, urea resins, melamine resins, and crosslinkable thermosetting resins other than these), and photocurable resins (specific examples include epoxy-acrylic acid resins and urethane-acrylic acid copolymers).

### <Electron Transport Material>

The electron transport material includes a compound represented by formula (11), (12), (13), (14), (15), (16), or (17) (also referred to below as electron transport materials (11), (12), (13), (14), (15), (16), or (17), respectively). The electron transport materials (11) to (17) favorably extract electrons from the charge generating material and rapidly transport the electrons extracted from the charge generating material. Therefore, presence of the electron transport materials (11) to (17) in the photosensitive layer reduces the charge remaining in the photosensitive layer, thereby inhibiting transfer memory.

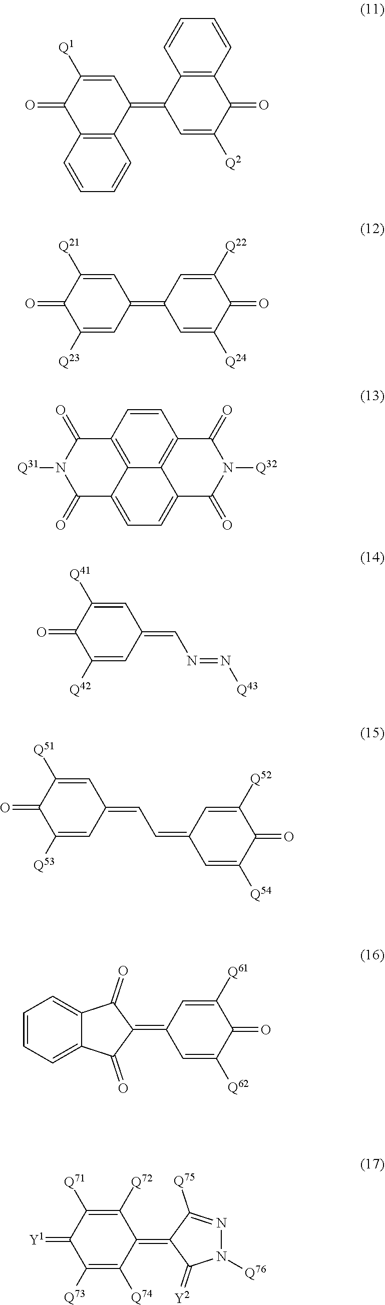

Q¹ and Q² in formula (11), Q²¹, Q²², Q²³, and Q²⁴ in formula (12), Q³¹ and Q³² in formula (13), Q⁴¹, Q⁴², and Q⁴³ in formula (14), Q⁵¹, Q⁵², Q⁵³, and Q⁵⁴ in formula (15), Q⁶¹ and Q⁶² in formula (16), and Q⁷¹, Q⁷², Q⁷³, Q⁷⁴, Q⁷⁵, and Q⁷⁶ in formula (17) each represent, independently of one another, a hydrogen atom, a halogen atom, a cyano group, an alkyl group with a carbon number of at least 1 and no greater than 6, an alkenyl group with a carbon number of at least 2 and no greater than 6, an alkoxy group with a carbon number of at least 1 and no greater than 6, or an aryl group with a carbon number of at least 6 and no greater than 14 optionally substituted with at least one selected from the group consisting of a halogen atom and an alkyl group with a carbon number of at least 1 and no greater than 6. In formula (A16), Y¹ and Y² each represent, independently of one another, an oxygen atom or a sulfur atom.

Preferably, Q¹ and Q² in formula (11), Q²¹, Q²², Q²³, and Q²⁴ in formula (12), Q³¹ and Q³² in formula (13), Q⁴¹, Q⁴², and Q⁴³ in formula (14), Q⁵¹, Q⁵², Q⁵³, and Q⁵⁴ in formula (15), Q⁶¹ and Q⁶² in formula (16), and Q⁷¹, Q⁷², Q⁷³, Q⁷⁴, Q⁷⁵, and Q⁷⁶ in formula (17) each represent, independently of one another, a hydrogen atom, an alkyl group with a carbon number of at least 1 and no greater than 6, or an aryl group with a carbon number of at least 6 and no greater than 14 optionally substituted with at least one selected from the group consisting of a halogen atom and an alkyl group with a carbon number of at least 1 and no greater than 6. Preferably, Y¹ and Y² each represent an oxygen atom.

The alkyl group with a carbon number of at least 1 and no greater than 6 represented by any of Q¹ and Q² in formula (11), Q²¹, Q²², Q²³, and Q²⁴ in formula (12), Q³¹ and Q³² in formula (13), Q⁴¹, Q⁴², and Q⁴³ in formula (14), Q⁵¹, Q⁵², Q⁵³, and Q⁵⁴ in formula (15), Q⁶¹ and Q⁶² in formula (16), and Q⁷¹, Q⁷², Q⁷³, Q⁷⁴, Q⁷⁵, and Q⁷⁶ in formula (17) is preferably an alkyl group with a carbon number of at least 1 and no greater than 5, more preferably a methyl group, an ethyl group, a propyl, a butyl group, or a pentyl group, and particularly preferably a methyl group, an isopropyl group, a tert-butyl group, or a 1,1-dimethylpropyl group.

The aryl group with a carbon number of at least 6 and no greater than 14 represented by any of Q¹ and Q² in formula (11), Q²¹, Q²², Q²³, and Q²⁴ in formula (12), Q³¹ and Q³² in formula (13), Q⁴¹, Q⁴², and Q⁴³ in formula (14), Q⁵¹, Q⁵², Q⁵³, and Q⁵⁴ in formula (15), Q⁶¹ and Q⁶² in formula (16), and Q⁷¹, Q⁷², Q⁷³, Q⁷⁴, Q⁷⁵, and Q⁷⁶ in formula (17) is preferably an aryl group with a carbon number of at least 6 and no greater than 10, and more preferably a phenyl group. The aryl group with a carbon number of at least 6 and no greater than 14 may be substituted with at least one substituent selected from the group consisting of a halogen atom and an alkyl group with a carbon number of at least 1 and no greater than 6. The alkyl group with a carbon number of at least 1 and no greater than 6 being a substituent is preferably an alkyl group with a carbon number of at least 1 and no greater than 3, and more preferably a methyl group or an ethyl group. The halogen atom being a substituent is preferably a fluorine atom, a chlorine atom, or a bromine atom, and particularly preferably a chlorine atom. Where the aryl group with a carbon number of at least 6 and no greater than 14 is substituted with a substituent(s), the number of the substituents is preferably at least 1 and no greater than 5, and more preferably 1 or 2. The aryl group with a carbon number of at least 6 and no greater than 14 substituted with at least one substituent selected from the group consisting of a halogen atom and an alkyl group with a carbon number of at least 1 and no greater than 6 is preferably a chlorophenyl group, a dichlorophenyl group, or an ethylmethylphenyl group, and more preferably a 4-chlorophenyl group, a 2,5-dichlorophenyl group, or a 2-ethyl-6-methylphenyl group.

Preferable examples of the electron transport material include compounds represented by formulas (E-1) to (E-8) (also referred to below as electron transport materials (E-1) to (E-8), respectively).

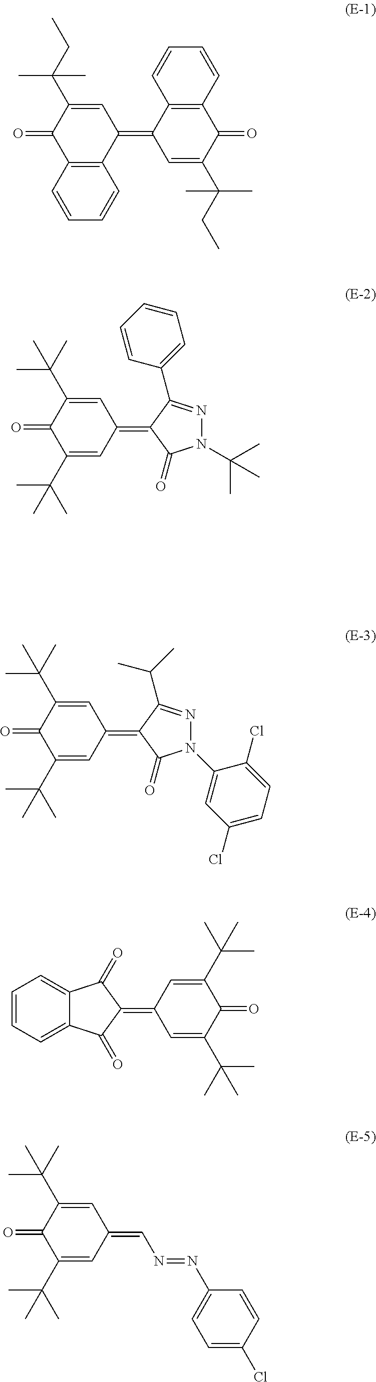 [SMILES: CCC(C)(C)C1=C/C(=C2/C=C(C(C)(C)CC)C(=O)c3ccccc32)c2ccccc2C1=O ; CC(C)(C)C1=CC(=C2C(=O)N(C(C)(C)C)N=C2c2ccccc2)C=C(C(C)(C)C)C1=O ; CC(C)C1=NN(c2cc(Cl)ccc2Cl)C(=O)C1=C1C=C(C(C)(C)C)C(=O)C(C(C)(C)C)=C1 ; CC(C)(C)C1=CC(=C2C(=O)c3ccccc3C2=O)C=C(C(C)(C)C)C1=O ; CC(C)(C)C1=CC(=C/N=N/c2ccc(Cl)cc2)C=C(C(C)(C)C)C1=O]

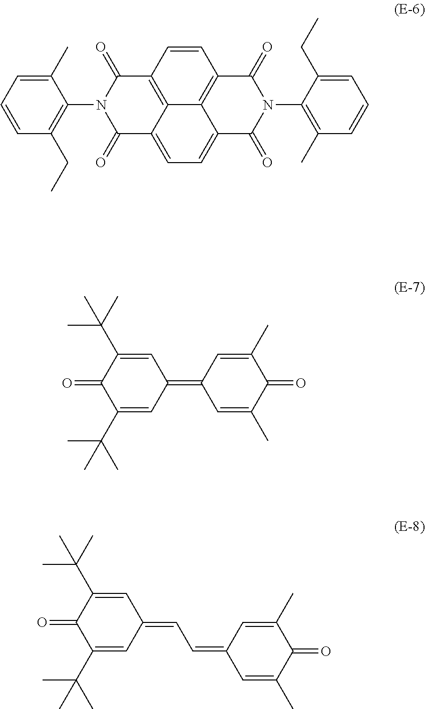 [SMILES: CCc1cccc(C)c1N1C(=O)c2ccc3c4c(ccc(c24)C1=O)C(=O)N(c1c(C)cccc1CC)C3=O ; CC1=CC(=C2C=C(C(C)(C)C)C(=O)C(C(C)(C)C)=C2)C=C(C)C1=O ; CC1=CC(=CC=C2C=C(C(C)(C)C)C(=O)C(C(C)(C)C)=C2)C=C(C)C1=O]

The percentage content of the electron transport material is preferably at least 15% by mass and no greater than 35% by mass to the mass of the photosensitive layer, more preferably at least 15% by mass and no greater than 33% by mass, and further preferably at least 20% by mass and no greater than 25% by mass.

The photosensitive layer may contain only one of the electron transport materials (11), (12), (13), (14), (15), (16), or (17), or may contain two or more of them. The photosensitive layer may contain only any of the electron transport materials (11) to (17), or may further contain an electron transport material other than the electron transport materials (11) to (17) (hereinafter, also refers to as an additional electron transport material). The percentage content of any of the electron transport materials (11) to (17) in the electron transport material is preferably at least 80% by mass, more preferably at least 90% by mass, further preferably at least 95% by mass, and particularly preferably 100% by mass.

Examples of the additional electron transport material include quinone-based compounds, diimide-based compounds, hydrazone-based compounds, malononitrile-based compounds, thiopyran-based compounds, trinitrothioxanthone-based compounds, 3,4,5,7-tetranitro-9-fluorenone-based compounds, dinitroanthracene-based compounds, dinitroacridine-based compounds, tetracyanoethylene, 2,4,8-trinitrothioxanthone, dinitrobenzene, dinitroacridine, succinic anhydride, maleic anhydride, and dibromomaleic anhydride. Examples of the quinone-based compounds include diphenoquinone-based compounds, azaquinone-based compounds, anthraquinone-based compounds, naphthoquinone-based compounds, nitroanthraquinone-based compounds, and dinitroanthraquinone-based compounds.

With respect to 100 parts by mass of the binder resin, the content of the electron transport material is preferably at least 5 parts by mass and no greater than 150 parts by mass, more preferably at least 10 parts by mass and no greater than 100 parts by mass, and further preferably at least 30 parts by mass and no greater than 70 parts by mass.

### <Hole Transport Material>

The hole transport material includes a compound represented by formula (20), (21), or (22) (also referred to below as hole transport materials (20), (21), and (22), respectively). The hole transport materials (20) to (22) tend to transport holes more rapidly than hole transport materials with a diamine structure. Presence of the hole transport materials (20) to (22) in the photosensitive layer reduces the charge remaining in the photosensitive layer, thereby inhibiting transfer memory.

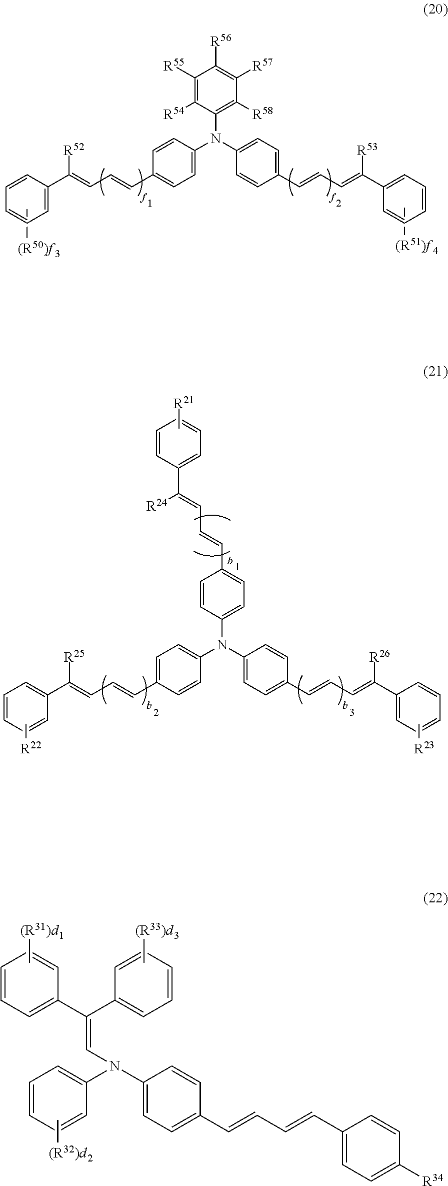

In formula (20), R⁵⁰ and R⁵¹ each represent, independently of one another, a phenyl group, an alkyl group with a carbon number of at least 1 and no greater than 6, or an alkoxy group with a carbon number of at least 1 and no greater than 6. R⁵², R⁵³, R⁵⁴, R⁵⁵, R⁵⁶, R⁵⁷, and R⁵⁸ each represent, independently of one another, a hydrogen atom, an alkyl group with a carbon number of at least 1 and no greater than 6, an alkoxy group with a carbon number of at least 1 and no greater than 6, or a phenyl group optionally substituted with an alkyl group with a carbon number of at least 1 and no greater than 6. f₁ and f₂ each represent, independently of one another, an integer of at least 0 and no greater than 2. f₃ and f₄ each represent, independently of one another, an integer of at least 0 and no greater than 5.

Where f₃ in formula (20) represents an integer of at least 2 and no greater than 5, the chemical groups R⁵⁰ may represent the same group as or different groups from one another. Where f₄ represents an integer of at least 2 and no greater than 5, the chemical groups R⁵¹ may represent the same group as or different groups from one another.

Preferably, R⁵⁰ and R⁵¹ in formula (20) each represent, independently of one another, an alkyl group with a carbon number of at least 1 and no greater than 6. Preferably, R⁵² and R⁵³ each represent a hydrogen atom or a phenyl group optionally substituted with an alkyl group with a carbon number of at least 1 and no greater than 6. Preferably, R⁵⁴ to R⁵⁸ each represent, independently of one another, a hydrogen atom, an alkyl group with a carbon number of at least 1 and no greater than 6, or an alkoxy group with a carbon number of at least 1 and no greater than 6. Preferably, f₁ and f₂ each represent 0, 1, or 2. Preferably, f₃ and f₄ each represent, independently of one another, 0 or 1.

The alkyl group with a carbon number of at least 1 and no greater than 6 represented by R⁵⁰ and R⁵¹ is preferably an alkyl group with a carbon number of at least 1 and no greater than 3, and more preferably a methyl group. The phenyl group optionally substituted with an alkyl group with a carbon number of at least 1 and no greater than 6 that is represented by R⁵² and R⁵³ is preferably a phenyl group or a phenyl group substituted with an alkyl group with a carbon number of at least 1 and no greater than 3. The phenyl group substituted with an alkyl group with a carbon number of at least 1 and no greater than 3 is preferably a methylphenyl group, and more preferably a 4-methylphenyl group. The alkyl group with a carbon number of at least 1 and no greater than 6 represented by any of R⁵⁴ to R⁵⁸ is preferably an alkyl group with a carbon number of at least 1 and no greater than 4, and more preferably a methyl group, an ethyl group, or an n-butyl group. The alkoxy group with a carbon number of at least 1 and no greater than 6 represented by any of R⁵⁴ to R⁵⁸ is preferably an alkoxy group with a carbon number of at least 1 and no greater than 3, and more preferably an ethoxy group.

In formula (21), R²¹, R²², and R²³ each represent, independently of one another, an alkyl group with a carbon number of at least 1 and no greater than 6. R²⁴, R²⁵, and R²⁶ each represent, independently of one another, a hydrogen atom or an alkyl group with a carbon number of at least 1 and no greater than 6. b₁, b₂, and b₃ each represent, independently of one another, 0 or 1.

In formula (21), R²¹, R²², and R²³ each represent, independently of one another, preferably an alkyl group with a carbon number of at least 1 and no greater than 3, and more preferably a methyl group. R²¹, R²², and R²³ are preferably bonded to a phenyl group at a meta-position of the phenyl group relative to an ethenyl group or a butadienyl group. Preferably, R²⁴, R²⁵, and R²⁶ each represent a hydrogen atom. Preferably, b₁, b₂, and b₃ each represent 0 or each represent 1.

In formula (22), R³¹, R³², and R³³ each represent, independently of one another, an alkyl group with a carbon number of at least 1 and no greater than 6. R³⁴ represents a hydrogen atom or an alkyl group with a carbon number of at least 1 and no greater than 6. d₁, d₂, and d₃ each represent, independently of one another, an integer of at least 0 and no greater than 5.

Where d₁ in formula (22) represents an integer of at least 2 and no greater than 5, the chemical groups R³¹ may be the same group as or different groups from one another. Where d₂ represents an integer of at least 2 and no greater than 5, the chemical groups R³² may represent the same group as or different groups from one another. Where d₃ represents an integer of at least 2 and no greater than 5, the chemical groups R³³ may represent the same group as or different groups from one another.

Preferably, R³⁴ in formula (22) represents a hydrogen atom. Preferably, d₁, d₂, and d₃ each represent 0.

Preferable examples of the hole transport material include compounds represented by formulas (H-1) to (H-8) (also referred to below as hole transport materials (H-1) to (H-8), respectively).

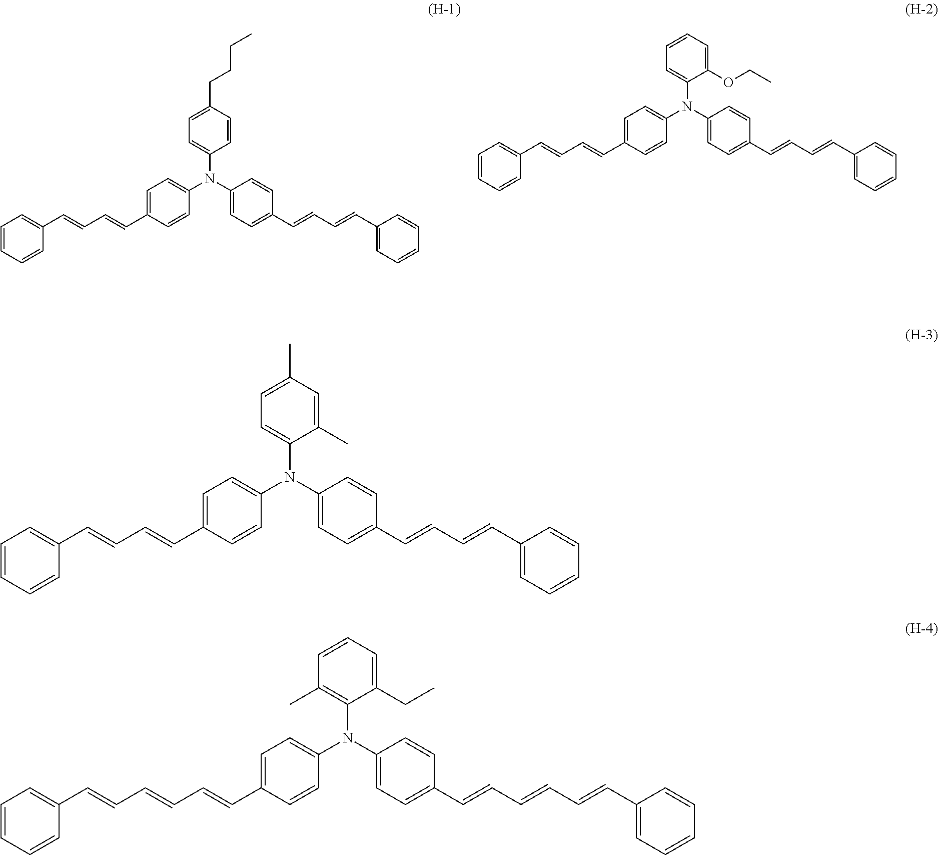 [SMILES: CCCCc1ccc(N(c2ccc(/C=C/C=C/c3ccccc3)cc2)c2ccc(/C=C/C=C/c3ccccc3)cc2)cc1 ; CCOc1ccccc1N(c1ccc(/C=C/C=C/c2ccccc2)cc1)c1ccc(/C=C/C=C/c2ccccc2)cc1 ; Cc1ccc(N(c2ccc(/C=C/C=C/c3ccccc3)cc2)c2ccc(/C=C/C=C/c3ccccc3)cc2)c(C)c1 ; CCc1cccc(C)c1N(c1ccc(/C=C/C=C/C=C/c2ccccc2)cc1)c1ccc(/C=C/C=C/C=C/c2ccccc2)cc1]

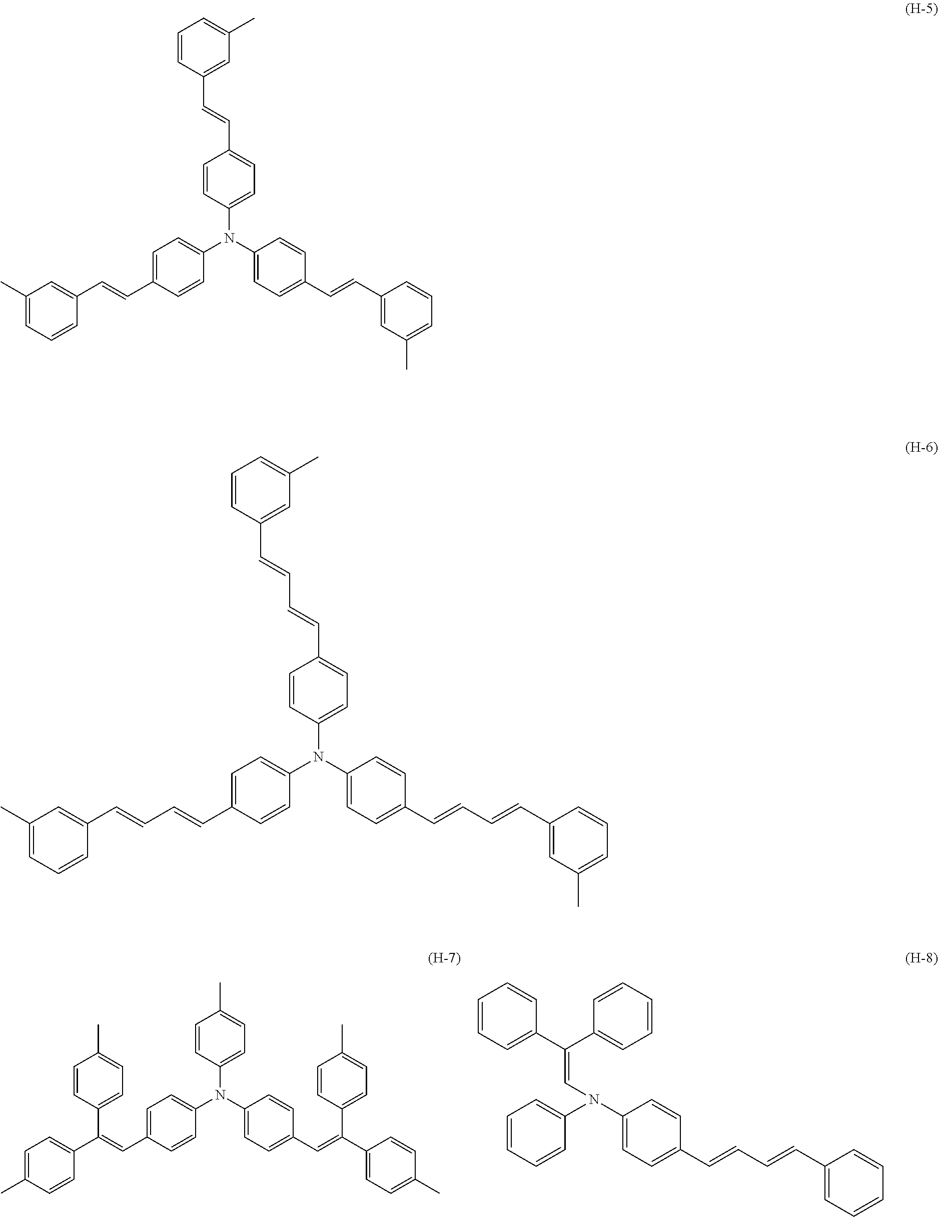

The photosensitive layer may contain only one of the hole transport materials (20), (21), or (22), or may contain two or more of them. The photosensitive layer may contain only any of the hole transport materials (20) to (22), or may further contain a hole transport material other than the electron transport materials (20) to (22) (also refers to below as an additional hole transport material). The content ratio of the hole transport materials (20) to (22) in the hole transport material is preferably at least 80% by mass, more preferably at least 90% by mass, further preferably at least 95% by mass, and particularly preferably 100% by mass.

Examples of the additional hole transport material include triphenylamine derivatives, diamine derivatives (e.g., an N,N,N′,N′-tetraphenylbenzidine derivative, an N,N,N′,N′-tetraphenylphenylenediamine derivative, an N,N,N′,N′-tetraphenylnaphthylenediamine derivative, an N,N,N′,N′-tetraphenylphenantolylenediamine derivative, and an di(aminophenylethenyl)benzene derivative), oxadiazole-based compounds (e.g., 2,5-di(4-methylaminophenyl)-1,3,4-oxadiazole), styryl-based compounds (e.g., 9-(4-diethylaminostyryl)anthracene), carbazole-based compounds (e.g., polyvinylcarbazole), organic polysilane compounds, pyrazoline-based compounds (e.g., 1-phenyl-3-(p-dimethylaminophenyl)pyrazoline), hydrazone-based compounds, indole-based compounds, oxazole-based compounds, isoxazole-based compounds, thiazole-based compounds, thiadiazole-based compounds, imidazole-based compounds, pyrazole-based compounds, and triazole-based compounds.

The hole transport material has a content of preferably at least 10 parts by mass and no greater than 200 parts by mass relative to 100 parts by mass of the binder resin, more preferably at least 50 parts by mass and no greater than 150 parts by mass, and further preferably at least 70 parts by mass and no greater than 130 parts by mass.

### <Specific Additive>

Preferably, the photosensitive layer further contains a compound represented by formula (30) or (31) (also referred to below as additives (30) and (31), respectively). In the following, the additives (30) and (31) are each generally referred to as a “specific additive”. When the specific additive fills fine pores of the polyarylate resin (PA) in the photosensitive layer, gaseous discharge products hardly enter the photosensitive layer. As a result, occurrence of transfer memory can be further inhibited. Combination of polyarylate resin (PA) and the specific additive can further inhibit transfer memory. Furthermore, as a result of the photosensitive layer containing the polyarylate resin (PA) and the specific additive, layer density of the photosensitive layer increases to further improve abrasion resistance of the photosensitive member.

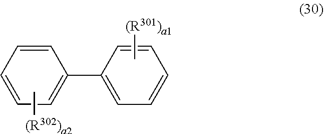

In formula (30), R³⁰¹ and R³⁰² each represent, independently of one another, a nitro group, an aryl group with a carbon number of at least 6 and no greater than 14, or an alkyl group with a carbon number of at least 1 and no greater than 6 optionally substituted with an aryl group with a carbon number of at least 6 and no greater than 14, a1 and a2 each represent, independently of one another, an integer of at least 0 and no greater than 5.

Where a1 in formula (30) represents an integer of at least 2 and no greater than 5, the chemical groups R³⁰¹ may represent the same group as or different groups from one another. Where a2 represents an integer of at least 2 and no greater than 5, the chemical groups R³⁰² may represent the same group as or different groups from one another.

In formula (30), R³⁰¹ and R³⁰² each represent preferably an aryl group with a carbon number of at least 6 and no greater than 14, more preferably an aryl group with a carbon number of at least 6 and no greater than 10, and further preferably a phenyl group. Preferably, a1 and a2 each represent, independently of one another, 0 or 1. It is preferable that one of a1 and a2 represents 0 while the other represents 1.

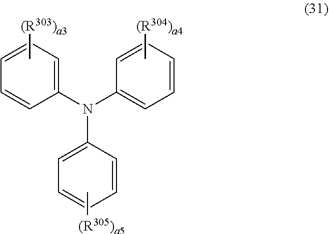

In formula (31), R³⁰³, R³⁰⁴, and R³⁰⁵ each represent, independently of one another, an alkyl group with a carbon number of at least 1 and no greater than 6 or an alkoxy group with a carbon number of at least 1 and no greater than 6, a3, a4, and a5 each represent, independently of one another, an integer of at least 0 and no greater than 5.

Where a3 in formula (31) represents an integer of at least 2 and no greater than 5, the chemical groups R³⁰³ may represent the same group as or different groups from one another. Where a4 represents an integer of at least 2 and no greater than 5, the chemical groups R³⁰⁴ may represent the same group as or different groups from one another. Where a5 represents an integer of at least 2 and no greater than 5, the chemical groups R³⁰⁵ may represent the same group as or different groups from one another.

In formula (31), R³⁰³, R³⁰⁴, and R³⁰⁵ each represent, independently of one another, preferably an alkyl group with a carbon number of at least 1 and no greater than 6, more preferably an alkyl group with a carbon number of at least 1 and no greater than 3, and further preferably a methyl group, a3, a4, and a5 each represent, independently of one another, preferably 0 or 1, and more preferably each represent 1.

Preferable examples of the specific additive include compounds represented by formulas (ADD-1) and (ADD-2) (also referred to below as an additives (ADD-1) and (ADD-2), respectively).

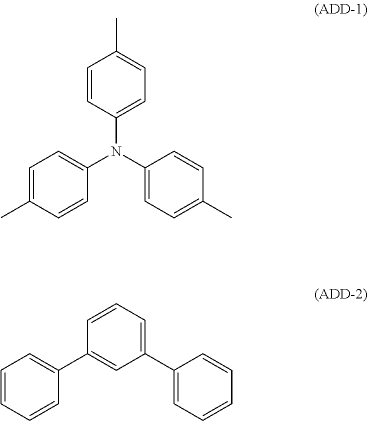

In order to further inhibit occurrence of transfer memory, the specific additive is preferably the additive (30), and more preferably the additive (ADD-2).

The specific additive has a content of at least 5 parts by mass and no greater than 20 parts by mass relative to 100 parts by mass of the binder resin. The photosensitive layer may contain only one specific additive or may contain two or more specific additives.

### <Additional Additive>

The photosensitive layer may further contain an additional additive other than the specific additive as an additive. Examples of the additional additive include an ultraviolet absorbing agent, an antioxidant, a radical scavenger, a singlet quencher, a softener, a surface modifier, an extender, a thickener, a dispersion stabilizer, a wax, a donor, a surfactant, a plasticizer, a sensitizer, an electron acceptor compound, and a leveling agent. However, the photosensitive layer may not contain the additional additive.

### <Conductive Substrate>

No particular limitations are placed on the conductive substrate so long as at least a surface portion of the conductive substrate is constituted by a conductive material. One example of the conductive substrate is a conductive substrate constituted by a conductive material. Another example of the conductive substrate is a conductive substrate covered with a conductive material. Examples of the conductive material include aluminum, iron, copper, tin, platinum, silver, vanadium, molybdenum, chromium, cadmium, titanium, nickel, palladium, indium, stainless steel, and brass. Among these conductive materials, aluminum or an aluminum alloy is preferable in terms of favorable charge movement from the photosensitive layer to the conductive substrate.

The shape of the conductive substrate is selected as appropriate according to the configuration of an image forming apparatus including the photosensitive member. The conductive substrate may be in the form of a sheet or a dram, for example. Furthermore, the thickness of the conductive substrate is selected as appropriate according to the shape of the conductive substrate.

### <Intermediate Layer>

The intermediate layer (undercoat layer) contains inorganic particles and a resin (intermediate layer resin) for intermediate layer use. Presence of the intermediate layer can facilitate flow of current generated when the photosensitive member is exposed to light and inhibit increasing resistance, while also maintaining insulation to a sufficient degree so as to inhibit occurrence of leakage current.

Examples of the inorganic particles include particles of metals (e.g., aluminum, iron, and copper), particles of metal oxides (e.g., titanium oxide, alumina, zirconium oxide, tin oxide, and zinc oxide), and particles of non-metal oxides (e.g., silica).

Examples of the intermediate layer resin are the same as the examples of the additional binder resin listed previously. In order to favorably form the intermediate layer and the photosensitive layer, the intermediate layer resin is preferably different from the binder resin contained in the photosensitive layer. The intermediate layer may contain an additive. Examples of the additive contained in the intermediate layer are the same as the examples of the additional additive listed previously.

### <Photosensitive Member Production Method>

One example of a photosensitive member production method is described below. The photosensitive member production method includes a photosensitive layer formation process, for example. In the photosensitive layer formation process, an application liquid (also referred to below as an application liquid for photosensitive layer formation) for forming a photosensitive layer is prepared. The application liquid for photosensitive layer formation is applied onto a conductive substrate. Next, a photosensitive layer is formed by removing at least a portion of a solvent contained in the applied application liquid for photosensitive layer formation. The application liquid for photosensitive layer formation contains the charge generating material, the binder resin, the electron transport material, the hole transport material, and the solvent, for example. The application liquid for photosensitive layer formation is prepared by dissolving or dispersing the charge generating material, the binder resin, the electron transport material, and the hole transport material in the solvent. The application liquid for photosensitive layer formation may further contain the specific additive and the additional additive as necessary.

No particular limitations are placed on the solvent contained in the application liquid for photosensitive layer formation so long as the solvent can dissolve or disperse each component contained in the application liquid for photosensitive layer formation. Examples of the solvent include alcohols (specific examples include methanol, ethanol, isopropanol, and butanol), aliphatic hydrocarbons (specific examples include n-hexane, octane, and cyclohexane), aromatic hydrocarbons (specific examples include benzene, toluene, and xylene), halogenated hydrocarbons (specific examples include dichloromethane, dichloroethane, carbon tetrachloride, and chlorobenzene), ethers (specific examples include dimethyl ether, diethyl ether, tetrahydrofuran, ethylene glycol dimethyl ether, and diethylene glycol dimethyl ether), ketones (specific examples include acetone, methyl ethyl ketone, and cyclohexanone), esters (specific examples include ethyl acetate and methyl acetate), dimethyl formaldehyde, dimethyl formamide, and dimethyl sulfoxide.

The application liquid for photosensitive layer formation is prepared by mixing each component and dispersing the resultant mixture in the solvent. Mixing and dispersion may be performed using a bead mill, a roll mill, a ball mill, an attritor, a paint shaker, or an ultrasonic disperser, for example.

No particular limitations are placed on a method for applying the application liquid for photosensitive layer formation so long as the application liquid for photosensitive layer formation can be uniformly applied. Examples of the application method include dip coating, spray coating, spin coating, and bar coating.

Examples of a method for removing at least a portion of the solvent contained in the application liquid for photosensitive layer formation include heating, pressure reduction, and a combination of heating and pressure reduction. More specifically, the method may be thermal treatment (hot-air drying) using a high-temperature dryer or a reduced pressure dryer. The temperature of the thermal treatment is at least 40° C. and no greater than 150° C., for example. The thermal treatment time is at least 3 minutes and no greater than 120 minutes, for example.

Note that the photosensitive member production method may further include either or both an intermediate layer formation process and a protective layer formation process as necessary. Any known methods can be selected as appropriate as the intermediate layer formation process and the protective layer formation process.

### Second Embodiment: Image Forming Apparatus

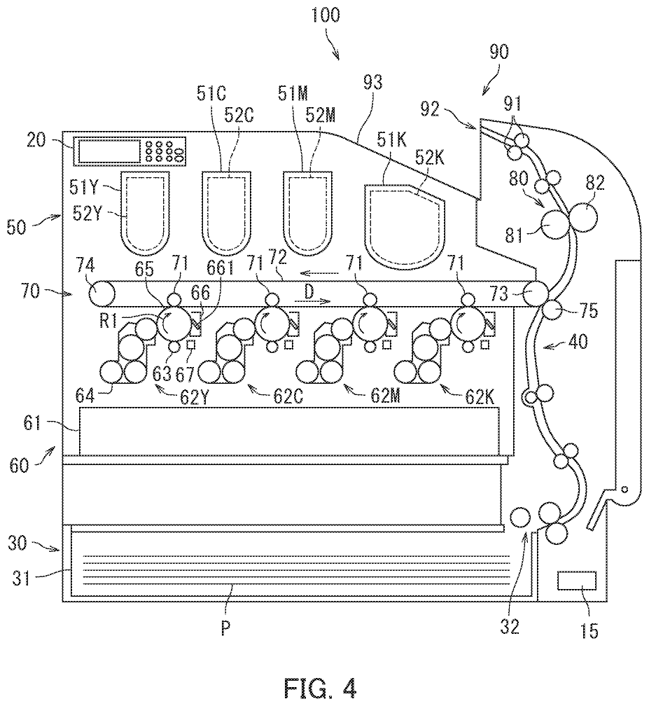

With reference to FIG. 4, an image forming apparatus 100 according to a second embodiment of the present disclosure is described next. FIG. 4 illustrates an example of the configuration of the image forming apparatus 100. The image forming apparatus 100 is a tandem color printer, for example.

As illustrated in FIG. 4, the image forming apparatus 100 includes a controller 15, an operation section 20, a sheet feed section 30, a conveyance section 40, a toner replenishing section 50, an image forming section 60, a transfer device 70, a fixing device 80, and an ejection section 90.

The controller 15 controls operation of each element included in the image forming apparatus 100. The controller 15 includes a processor (not illustrated) and storage (not illustrated). The processor includes a central processing unit (CPU), for example. The storage includes memory such as semiconductor memory, and may include a hard disk drive (HDD). The processor executes control programs to control the operation of the image forming apparatus 100. The storage stores the control programs therein.

The operation section 20 receives instructions from a user. Upon receiving an instruction from the user, the operation section 20 transmits a signal indicating the instruction from the user to the controller 15. As a result, image forming operation by the image forming apparatus 100 starts.

The sheet feed section 30 includes a sheet feed cassette 31 and a sheet feed roller group 32. The sheet feed cassette 31 accommodates a plurality of sheets P of a recording medium (e.g., paper). The sheet feed roller group 32 feeds the sheets P accommodated in the sheet feed cassette 31 one at a time to the conveyance section 40.

The conveyance section 40 includes a roller and a guide member. The conveyance section 40 extends from the sheet feed section 30 to the ejection section 90. The conveyance section 40 conveys the sheet P from the sheet feed section 30 to the ejection section 90 via the image forming section 60 and the fixing device 80.

The toner replenishing section 50 replenishes the image forming section 60 with toners. The toner replenishing section 50 includes a first fitting portion 51Y, a second fitting portion 51C, a third fitting portion 51M, and a fourth fitting portion 51K.

In the first fitting portion 51Y, a first toner container 52Y is fitted. Likewise, a second toner container 52C is fitted in the second fitting portion 51C, a third toner container 52M is fitted in the third fitting portion 51M, and a fourth toner container 52K is fitted in the fourth fitting portion 51K.

The first toner container 52Y, the second toner container 52C, the third toner container 52M, and the fourth toner container 52K each accommodate a toner. In the second embodiment, the first toner container 52Y accommodates a yellow toner. The second toner container 52C accommodates a cyan toner. The third toner container 52M accommodates a magenta toner. The fourth toner container 52K accommodates a black toner.

The image forming section 60 includes a light exposure device 61, a first image forming unit 62Y, a second image forming unit 62C, a third image forming unit 62M, and a fourth image forming unit 62K.

The first image forming unit 62Y to the fourth image forming unit 62K each include a charger 63, a development device 64, an image bearing member 65, a cleaner 66, and a static eliminator 67.

Note that the configurations of the first image forming unit 62Y to the fourth image forming unit 62K are the same as each other except that the types of the toners supplied from the toner replenishing section 50 are different from each other. As such, reference signs are omitted for each element of configuration included in the second image forming unit 62C to the fourth image forming unit 62K in FIG. 4.

The image bearing member 65 is the photosensitive member 1 of the first embodiment. As described in the first embodiment, the photosensitive member 1 of the first embodiment has excellent abrasion resistance, filming resistance, and scratch resistance. As such, the image forming apparatus 100 of the second embodiment includes the photosensitive member 1 which has excellent abrasion resistance, filming resistance, and scratch resistance.

The image bearing member 65 in the second embodiment rotates in a direction (clockwise direction in FIG. 4) indicated by an arrow R1 in FIG. 4. The charger 63, the development device 64, the cleaner 66, and the static eliminator 67 are disposed around the circumferential surface of the image bearing member 65 in the stated order from upstream in terms of the rotation direction of the image bearing member 65.

The charger 63 charges the surface (circumferential surface) of the image bearing member 65. The charger 63 uniformly charges the image bearing member 65 to a specific polarity by discharging. The surface of the image bearing member 65 is charged to the positive polarity, for example. The charger 63 is a charging roller, for example.

The light exposure device 61 exposes the charged surface of the image bearing member 65 with light. In detail, the light exposure device 61 irradiates the charged surface of the image bearing member 65 with laser light. This forms an electrostatic latent image on the surface of the image bearing member 65.

The development device 64 is replenished with a toner from the toner replenishing section 50. The development device 64 supplies the toner from the toner replenishing section 50 to the surface of the image bearing member 65. As a result, the electrostatic latent image formed on the surface of the image bearing member 65 is developed into a toner image.

The development device 64 of the first image forming unit 62Y is connected to the first toner container 52Y in the second embodiment. In the above configuration, the development device 64 of the first image forming unit 62Y is replenished with the yellow toner. Accordingly, a yellow toner image is formed on the surface of the image bearing member 65 of the first image forming unit 62Y.

Likewise, the development device 64 of the second image forming unit 62C, the development device 64 of the third image forming unit 62M, and the development device 64 of the fourth image forming unit 62K are respectively connected to the second toner container 52C, the third toner container 52M, and the fourth toner container 52K. In the above configuration, the development device 64 of the second image forming unit 62C, the development device 64 of the third image forming unit 62M, and the development device 64 of the fourth image forming unit 62K are respectively replenished with the cyan toner, the magenta toner, and the black toner. Accordingly, a cyan toner image, a magenta toner image, and a black toner image are respectively formed on the surface of the image bearing member 65 of the second image forming unit 62C, the surface of the image bearing member 65 of the third image forming unit 62M, and the surface of the image bearing member 65 of the fourth image forming unit 62K.

The cleaner 66 includes a cleaning member 661. After toner image transfer by a later-described primary transfer roller 71, the cleaner 66 collects toner attached to the surface of the image bearing member 65. In detail, the cleaner 66 presses the cleaning member 661 against the surface of the image bearing member 65 to collect toner attached to the surface of the image bearing member 65. The cleaning member 661 is a cleaning blade, for example.

The static eliminator 67 irradiates the surface of the image bearing member 65 with static elimination light to eliminate static electricity on the surface of the image bearing member 65.

The transfer device 70 transfers the toner images to the sheet P being a transfer target from the image bearing members 65. In detail, the transfer device 70 transfers the respective toner images formed on the surfaces of the image bearing members 65 of the first image forming unit 62Y to the fourth image forming unit 62K to the sheet P in a superimposed manner. In the second embodiment, the transfer device 70 transfers the toner images to the sheet P in a superimposed manner by the secondary transfer process (intermediate transfer process). The transfer device 70 includes four primary transfer rollers 71, an intermediate transfer belt 72, a drive roller 73, a driven roller 74, and a secondary transfer roller 75.

The intermediate transfer belt 72 is an endless belt wound among the four primary transfer rollers 71, the drive roller 73, and the driven roller 74. The intermediate transfer belt 72 is driven in response to rotation of the drive roller 73. The intermediate transfer belt 72 circulates in the anticlockwise direction in FIG. 4. The driven roller 74 is rotationally driven in response to circulation of the intermediate transfer belt 72.

The first image forming unit 62Y to the fourth image forming unit 62K are disposed opposite to the lower surface of the intermediate transfer belt 72. In the second embodiment, the first image forming unit 62Y to the fourth image forming unit 62K are disposed in the order of the first image forming unit 62Y to the fourth image forming unit 62K from upstream to downstream in terms of a driving direction D of the lower surface of the intermediate transfer belt 72.

The primary transfer rollers 71 are each disposed opposite to a corresponding one of the image bearing members 65 with the intermediate transfer belt 72 therebetween and are each pressed toward the corresponding image bearing members 65. In the above configuration, the toner images formed on the surfaces of the image bearing members 65 are sequentially transferred to the intermediate transfer belt 72 by the respective primary transfer rollers 71. In the second embodiment, the yellow toner image, the cyan toner image, the magenta toner image, and the black toner image are transferred in the stated order onto the intermediate transfer belt 72 in a superimposed manner. In the following, a toner image obtained by superimposing the yellow toner image, the cyan toner image, the magenta toner image, and the black toner image may be also referred to below as a “layered toner image”.

The secondary transfer roller 75 is disposed opposite to the drive roller 73 with the intermediate transfer belt 72 therebetween. The secondary transfer roller 75 is pressed toward the drive roller 73. In the above configuration, a transfer nip is formed between the secondary transfer roller 75 and the drive roller 73. When the sheet P passes through the transfer nip, the layered toner image on the intermediate transfer belt 72 is transferred to the sheet P by the secondary transfer roller 75. In the second embodiment, the yellow toner image, the cyan toner image, the magenta toner image, and the black toner image are transferred to the sheet P in the stated order as if the images became from the upper layer to the lower layer. The sheet P with the layered toner image transferred thereto is conveyed to the fixing device 80 by the conveyance section 40.

The fixing device 80 includes a heating member 81 and a pressure member 82. The heating member 81 and the pressure member 82 are disposed opposite to each other to form a fixing nip. The sheet P conveyed from the image forming section 60 is pressurized and heated at a specific fixing temperature when passing through the fixing nip. As a result, the layered toner image is fixed to the sheet P. The sheet P is conveyed from the fixing device 80 to the ejection section 90 by the conveyance section 40.

The ejection section 90 includes an ejection roller pair 91 and an exit tray 93. The ejection roller pair 91 conveys the sheet P to the exit tray 93 via an exit port 92. The exit port 92 is formed in an upper part of the image forming apparatus 100.

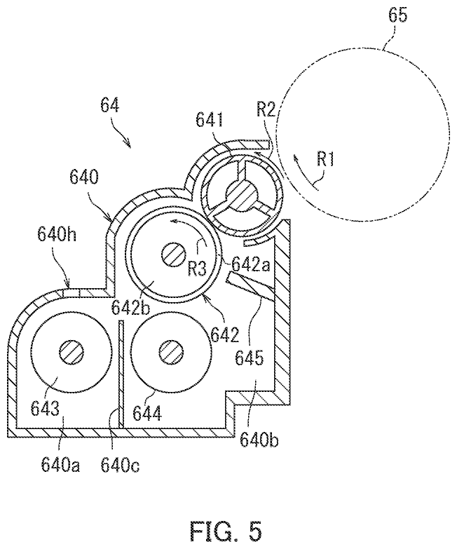

Details of the configuration of the development device 64 is described next with reference to FIG. 5. FIG. 5 illustrates an example of the configuration of the development device 64. In detail, FIG. 5 illustrates the development device 64 of the first image forming unit 62Y. Note that the image bearing member 65 is indicated by a dashed and double dotted line in FIG. 5 for the sake of easy understanding. In the second embodiment, the development device 64 adopts the touchdown development system and the two-component development system using a two-component developer.

As described previously with reference to FIG. 4, the developer container 640 of the development device 64 is connected to the first toner container 52Y. In the above configuration, the developer container 640 of the development device 64 is replenished with the yellow toner via a toner replenishment port 640h.

As illustrated in FIG. 5, the development device 64 includes in the interior of the developer container 640 a development roller 641, a magnetic roller 642, a first stirring screw 643, a second stirring screw 644, and a blade 645. In detail, the development roller 641 is disposed opposite to the magnetic roller 642. The magnetic roller 642 is disposed opposite to the second stirring screw 644. The blade 645 is disposed opposite to the magnetic roller 642.

The developer container 640 is partitioned into a first stirring chamber 640a and a second stirring chamber 640b by a partitioning wall 640c. The partitioning wall 640c extends in the axial direction of the development roller 641. The first stirring chamber 640a and the second stirring chamber 640b communicate with each other outside the opposite ends of the partitioning wall 640c in the longitudinal direction of the partitioning wall 640c.

The first stirring screw 643 is disposed in the first stirring chamber 640a. A carrier being a magnetic material is accommodated in the first stirring chamber 640a. The first stirring chamber 640a is replenished with a toner being a non-magnetic material via the toner replenishment port 640h. In the example illustrated in FIG. 5, the first stirring chamber 640a is replenished with the yellow toner.

The second stirring screw 644 is disposed in the second stirring chamber 640b. The carrier being a magnetic material is accommodated in the second stirring chamber 640b.

The first stirring screw 643 and the second stirring screw 644 stir the yellow toner and the carrier. As a result, a two-component developer containing the carrier and the yellow toner is made. As such, the two-component developer is accommodated in the developer container 640 (specifically, the first stirring chamber 640a and the second stirring chamber 640b).

The first stirring screw 643 and the second stirring screw 644 circulate and stir the two-component developer between the first stirring chamber 640a and the second stirring chamber 640b. As a result, the toner is charged to a specific polarity by friction with the carrier. The toner is charged to the positive polarity in the second embodiment.

The magnetic roller 642 includes a non-magnetic rotating sleeve 642a and a magnet 642b. The magnet 642b is disposed in a fixed state inside the rotating sleeve 642a. The magnet 642b includes a plurality of magnetic poles. The two-component developer is adsorbed to the magnetic roller 642 by the magnetic force of the magnet 642b. As a result, a magnetic brush is formed on the surface of the magnetic roller 642.

The blade 645 is disposed upstream of a location where the magnetic roller 642 is opposite to the development roller 641 in terms of the rotation direction of the magnetic roller 642. The magnetic roller 642 in the second embodiment rotates in a direction (anticlockwise direction in FIG. 5) indicated by an arrow R3 in FIG. 5. Rotation of the magnetic roller 642 transports the magnetic brush to a location opposite to the blade 645. The blade 645 is disposed to form a gap between the blade 645 and the magnetic roller 642. The blade 645 is constituted by a magnetic material. In the above configuration, the thickness of the magnetic brush is restricted by the magnetic force of the blade 645.

Once the thickness of the magnetic brush on the magnetic roller 642 is restricted, a specific voltage is applied to the magnetic roller 642 and the development roller 641. When the potential difference between the magnetic roller 642 and the development roller 641 reaches a specific potential difference as a result of application of the specific voltage, the yellow toner contained in the two-component developer moves to the development roller 641. As a result, a toner thin layer of the yellow toner is formed on the surface of the development roller 641.

The development roller 641 rotates in a direction (anticlockwise direction in FIG. 5) indicated by an arrow R2 in FIG. 5. Rotation of the development roller 641 transports the toner thin layer formed on the surface of the development roller 641 to a location opposite to the image bearing member 65 with a result that the toner thin layer is attached to the image bearing member 65. In the manner described above, the development device 64 supplies the toner charged by friction with the carrier to the surface of the image bearing member 65.

The development device 64 of the first image forming unit 62Y has been described so far with reference to FIG. 5. The configurations of the development devices 64 of the first image forming unit 62Y to the fourth image forming unit 62K are the same as each other except that the types of the toners supplied from the toner replenishing section 50 are different from each other. As such, description is omitted of the configuration of the development devices 64 of the second image forming unit 62C to the fourth image forming unit 62K.

The image forming apparatus 100 as an example of the image forming apparatus of the second embodiment has been described so far with reference to FIGS. 4 and 5. However, the image forming apparatus of the second embodiment is not limited to the image forming apparatus 100. For example, the image forming apparatus may be a monochrome image forming apparatus.

In this case, the image forming apparatus only needs to include a single image forming unit. The image forming apparatus may adopt the rotary system. The charger may be a charger (e.g., a scorotron charger, a charging brush, or a corotron charger) other than the charging roller. The image forming apparatus may adopt the one-component development system using a one-component developer. The image forming apparatus may adopt a development system (e.g., a development system not including a development roller and including a magnetic roller serving also as a development roller) other than the touchdown development system. The image forming apparatus may adopt the direct transfer process. Where the image forming apparatus adopts the direct transfer process, the toner images are directly transferred to a sheet of a recording medium from the image bearing members upon the image bearing members coming in contact with the sheet. The cleaning member may be a cleaning roller. The image forming apparatus may not include a cleaner. The image forming apparatus may not include a static eliminator. The image forming apparatus of the second embodiment has been described so far.

### Third Embodiment: Process Cartridge

Still referring to FIG. 4, a process cartridge according to a third embodiment of the present disclosure is described next. The process cartridge of the third embodiment corresponds to each of the first image forming unit 62Y to the fourth image forming unit 62K. The process cartridge includes an image bearing member 65. The image bearing member 65 is the photosensitive member 1 of the first embodiment. As described in the first embodiment, the photosensitive member 1 of the first embodiment has excellent abrasion resistance, filming resistance, and scratch resistance. As such, the process cartridge of the third embodiment accordingly includes the photosensitive member 1 which has excellent abrasion resistance, filming resistance, and scratch resistance.

The process cartridge may further include at least one (e.g., at least 1 and no greater than 6) selected from the group consisting of a charger 63, a light exposure device 61, a development device 64, a transfer device 70 (particularly, a primary transfer roller 71), cleaner 66, and a static eliminator 67 in addition to the image bearing member 65. The process cartridge is designed to be attachable to and detachable from an image forming apparatus 100. In the above configuration, the process cartridge is easy to handle and can be quickly replaced, including the image bearing member 65, when sensitivity characteristics or the like of the image bearing member 65 degrade. The process cartridge of the third embodiment has been described so far with reference to FIG. 4.

### [Substituents]

Details of the substituents used in the present specification are described below. Examples of the halogen atom (halogen group) include a fluorine atom (fluoro group), a chlorine atom (chloro group), a bromine atom (bromo group), and an iodine atom (iodine group).

The alkyl group with a carbon number of at least 1 and no greater than 6, the alkyl group with a carbon number of at least 1 and no greater than 5, the alkyl group with a carbon number of at least 1 and no greater than 4, and the alkyl group with a carbon number of at least 1 and no greater than 3 each are an unsubstituted straight chain or branched chain alkyl group unless otherwise stated. Examples of the alkyl group with a carbon number of at least 1 and no greater than 6 include a methyl group, an ethyl group, an n-propyl group, an isopropyl group, an n-butyl group, a sec-butyl group, a tert-butyl group, an n-pentyl group, a 1-methylbutyl group, a 2-methylbutyl group, a 3-methylbutyl group, a 1-ethylpropyl group, a 2-ethylpropyl group, a 1,1-dimethylpropyl group, a 1,2-dimethylpropyl group, a 2,2-dimethylpropyl group, an n-hexyl group, a 1-methylpentyl group, a 2-methylpentyl group, a 3-methylpentyl group, a 4-methylpentyl group, a 1,1-dimethylbutyl group, a 1,2-dimethylbutyl group, a 1,3-dimethylbutyl group, a 2,2-dimethylbutyl group, a 2,3-dimethylbutyl group, a 3,3-dimethylbutyl group, a 1,1,2-trimethylpropyl group, a 1,2,2-trimethylpropyl group, a 1-ethylbutyl group, a 2-ethylbutyl group, and a 3-ethylbutyl group. Examples of the alkyl group with a carbon number of at least 1 and no greater than 5, the alkyl group with a carbon number of at least 1 and no greater than 4, and the alkyl group with a carbon number of at least 1 and no greater than 3 are groups with corresponding carbon numbers among the groups listed as the examples of the alkyl group with a carbon number of at least 1 and no greater than 6.

The perfluoroalkyl group with a carbon number of at least 1 and no greater than 10, the perfluoroalkyl group with a carbon number of at least 3 and no greater than 10, the perfluoroalkyl group with a carbon number of at least 5 and no greater than 7, and the perfluoroalkyl group with a carbon number of 6 each are an unsubstituted straight chain or branched chain perfluoroalkyl group unless otherwise stated. Examples of the perfluoroalkyl group with a carbon number of at least 1 and no greater than 10 include a trifluoromethyl group, a perfluoroethyl group, a perfluoro-n-propyl group, a perfluoroisopropyl group, a perfluoro-n-butyl group, a perfluoro-sec-butyl group, a perfluoro-tert-butyl group, a perfluoro-n-pentyl group, a perfluoro-1-methylbutyl group, a perfluoro-2-methylbutyl group, a perfluoro-3-methylbutyl group, a perfluoro-1-ethylpropyl group, a perfluoro-2-ethylpropyl group, a perfluoro-1,1-dimethylpropyl group, a perfluoro-1,2-dimethylpropyl group, a perfluoro-2,2-dimethylpropyl group, a perfluoro-n-hexyl group, a perfluoro-1-methylpentyl group, a perfluoro-2-methylpentyl group, a perfluoro-3-methylpentyl group, a perfluoro-4-methylpentyl group, a perfluoro-1,1-dimethylbutyl group, a perfluoro-1,2-dimethylbutyl group, a perfluoro-1,3-dimethylbutyl group, a perfluoro-2,2-dimethylbutyl group, a perfluoro-2,3-dimethylbutyl group, a perfluoro-3,3-dimethylbutyl group, a perfluoro-1,1,2-trimethylpropyl group, a perfluoro-1,2,2-trimethylpropyl group, a perfluoro-1-ethylbutyl group, a perfluoro-2-ethylbutyl group, a perfluoro-3-ethylbutyl group, a straight chain or branched chain perfluoroheptyl group, a straight chain or branched chain perfluorooctyl group, a straight chain or branched chain perfluorononyl group, and a straight chain or branched chain perfluorodecyl group. Examples of the perfluoroalkyl group with a carbon number of at least 3 and no greater than 10, the perfluoroalkyl group with a carbon number of at least 5 and no greater than 7, and the perfluoroalkyl group with a carbon number of 6 are groups with corresponding carbon numbers among the groups listed as the examples of the perfluoroalkyl group with a carbon number of at least 1 and no greater than 10.

The alkanediyl group with a carbon number of at least 1 and no greater than 6 and the alkanediyl group with a carbon number of at least 1 and no greater than 3 each are an unsubstituted straight chain or branched chain alkanediyl group unless otherwise stated. Examples of the alkanediyl group with a carbon number of at least 1 and no greater than 6 include a methanediyl group (methylene group), an ethanediyl group, an n-propanediyl group, an isopropanediyl group, an n-butanediyl group, a sec-butanediyl group, a tert-butanediyl group, an n-pentanediyl group, a 1-methylbutanediyl group, a 2-methylbutanediyl group, a 3-methylbutanediyl group, a 1-ethylpropanediyl group, a 2-ethylpropanediyl group, a 1,1-dimethylpropanediyl group, a 1,2-dimethylpropanediyl group, a 2,2-dimethylpropanediyl group, an n-hexanediyl group, a 1-methylpentanediyl group, a 2-methylpentanediyl group, a 3-methylpentanediyl group, a 4-methylpentanediyl group, a 1,1-dimethylbutanediyl group, a 1,2-dimethylbutanediyl group, a 1,3-dimethylbutanediyl group, a 2,2-dimethylbutanediyl group, a 2,3-dimethylbutanediyl group, a 3,3-dimethylbutanediyl group, a 1,1,2-trimethylpropanediyl group, a 1,2,2-trimethylpropanediyl group, a 1-ethylbutanediyl group, a 2-ethylbutanediyl group, and a 3-ethylbutanediyl group. Examples of the alkanediyl group with a carbon number of at least 1 and no greater than 3 are groups with corresponding carbon numbers among the groups listed as the examples of the alkanediyl group with a carbon number of at least 1 and no greater than 6.

The alkoxy group with a carbon number of at least 1 and no greater than 6 and the alkoxy group with a carbon number of at least 1 and no greater than 3 each are an unsubstituted straight chain or branched chain alkoxy group unless otherwise stated. Examples of the alkoxy group with a carbon number of at least 1 and no greater than 6 include a methoxy group, an ethoxy group, an n-propoxy group, an isopropoxy group, an n-butoxy group, a sec-butoxy group, a tert-butoxy group, an n-pentoxy group, a 1-methylbutoxy group, a 2-methylbutoxy group, a 3-methylbutoxy group, a 1-ethylpropoxy group, a 2-ethylpropoxy group, a 1,1-dimethylpropoxy group, a 1,2-dimethylpropoxy group, a 2,2-dimethylpropoxy group, an n-hexyloxy group, a 1-methylpentyloxy group, a 2-ethylpentyloxy group, a 3-methylpentyloxy group, a 4-methylpentyloxy group, a 1,1-dimethylbutoxy group, a 1,2-dimethylbutoxy group, a 1,3-dimethylbutoxy group, a 2,2-dimethylbutoxy group, a 2,3-dimethylbutoxy group, a 3,3-dimethylbutoxy group, a 1,1,2-trimethylpropoxy group, a 1,2,2-trimethylpropoxy group, a 1-ethylbutoxy group, a 2-ethylbutoxy group, and a 3-ethylbutoxy group. Examples of the alkoxy group with a carbon number of at least 1 and no greater than 3 are groups with corresponding carbon numbers among the groups listed as the examples of the alkoxy group with a carbon number of at least 1 and no greater than 6.

The alkenyl group with a carbon number of at least 2 and no greater than 6 is an unsubstituted straight chain or branched chain alkenyl group unless otherwise stated. The alkenyl group with a carbon number of at least 2 and no greater than 6 has at least 1 and no greater than 3 double bonds. Examples of the alkenyl group with a carbon number of at least 2 and no greater than 6 include an ethenyl group, a propenyl group, a butenyl group, a butadienyl group, a pentenyl group, a hexenyl group, a hexadienyl group, and a hexatrienyl group.

The aryl group with a carbon number of at least 6 and no greater than 14 and the aryl group with a carbon number of at least 6 and no greater than 10 each are an unsubstituted aryl group unless otherwise stated. Examples of the aryl group with a carbon number of at least 6 and no greater than 14 include a phenyl group, a naphthyl group, an indacenyl group, a biphenylenyl group, an acenaphthylenyl group, an anthryl group, and a phenanthryl group. Examples of the aryl group with a carbon number of at least 6 and no greater than 10 include a phenyl group and a naphthyl group. Details of the substituents used in the present specification have been described so far.

### EXAMPLES

Specific description of the present disclosure is further made below using examples. However, the present disclosure is not limited to the scope of the examples.

### [Polyarylate Resins (R-1) to (R-7) and (R-D) to (R-S)]

Polyarylate resins (R-1) to (R-7) of examples and polyarylate resins (R-D) to (R-S) of comparative examples were synthesized by the following methods. In the following, the “polyarylate resins (R-1) to (R-7) and (R-D) to (R-S)” may be referred to as “resins (R-1) to (R-7) and (R-D) to (R-S)”, respectively. The respective compositions of the resins (R-1) to (R-7) and (R-D) to (R-S) are shown below in Tables 3 and 4.

TABLE 3

| | Monomer | | | | | | | | | | | |
|---|---|---|---|---|---|---|---|---|---|---|---|---|
| | | | | | | | | Dicarboxylic acid | | | | |
| | Bisphenol addition rate [%] | | | | | | | addition rate [%] | | | | |
| | BisCZ | BisB | BisC | BisZ | BisCE | BisA | DHPE | DPEC | TPC | IPC | Ter- | |
| | Unit | Unit | Unit | Unit | Unit | Unit | Unit | Unit | Unit | Unit | min- | Molecular |
| Resin | (1-1) | (1-2) | (BisC) | (BisZ) | (BisCE) | (BisA) | (3) | (2) | (4) | (IPC) | ator | weight |
| R-1 | 80 | — | — | — | — | — | 20 | 65 | 35 | — | DMP | 52000 |
| R-2 | — | 80 | — | — | — | — | 20 | 65 | 35 | — | DMP | 64200 |
| R-3 | 80 | — | — | — | — | — | 20 | 50 | 50 | — | DMP | 54500 |
| R-4 | 80 | — | — | — | — | — | 20 | 35 | 65 | — | DMP | 52700 |
| R-5 | — | 80 | — | — | — | — | 20 | 50 | 50 | — | DMP | 62300 |
| R-6 | 60 | — | — | — | — | — | 40 | 65 | 35 | — | DMP | 58000 |
| R-7 | 80 | — | — | — | — | — | 20 | 65 | 35 | — | PFH | 54300 |
| R-D | — | — | — | — | — | 100 | — | — | 50 | 50 | DMP | 55000 |
| R-E | — | — | — | 100 | — | — | — | — | 50 | 50 | DMP | 57500 |
| R-F | — | — | — | — | 100 | — | — | 100 | — | — | DMP | 56500 |

TABLE 4

| | Monomer | | | | | | | | | | | |
|---|---|---|---|---|---|---|---|---|---|---|---|---|
| | | | | | | | | Dicarboxylic acid | | | | |
| | Bisphenol addition rate [%] | | | | | | | addition rate [%] | | | | |
| | BisCZ | BisB | BisC | BisZ | BisCE | BisA | DHPE | DPEC | TPC | IPC | Ter- | |
| | Unit | Unit | Unit | Unit | Unit | Unit | Unit | Unit | Unit | Unit | min- | Molecular |
| Resin | (1-1) | (1-2) | (BisC) | (BisZ) | (BisCE) | (BisA) | (3) | (2) | (4) | (IPC) | ator | weight |
| R-G | 50 | — | — | — | — | — | 50 | 65 | 35 | — | DMP | 58600 |
| R-H | 80 | — | — | — | — | — | 20 | 100 | — | — | DMP | 57200 |
| R-I | 60 | — | — | — | — | — | 40 | 100 | — | — | DMP | 56600 |
| R-J | — | 80 | — | — | — | — | 20 | 100 | — | — | DMP | 61000 |
| R-K | — | — | — | 80 | — | — | 20 | 65 | 35 | — | DMP | Unmeasurable |
| R-L | — | — | 80 | — | — | — | 20 | 65 | 35 | — | DMP | 49900 |
| R-M | — | 80 | — | — | — | — | 20 | 50 | 25 | 25 | DMP | 50800 |
| R-N | 80 | — | — | — | — | — | 20 | 25 | 75 | — | DMP | 52100 |
| R-O | 100 | — | — | — | — | — | — | 65 | 35 | — | DMP | 53500 |
| R-P | — | — | — | 100 | — | — | — | 50 | 30 | 20 | DMP | Unmeasurable |
| R-Q | 80 | — | — | — | — | — | 20 | 65 | — | 35 | DMP | 48100 |
| R-R | — | — | — | — | 70 | — | 30 | 100 | — | — | DMP | 56900 |
| R-S | 80 | — | — | — | — | — | 20 | — | 100 | — | DMP | 42300 |

In Tables 3 and 4, “BisCZ”, “BisB”, “BisC”, “BisZ”, “BisCE, “BisA”, “DHPE”, “DPEC, “TPC”, and “IPC” respectively indicate compounds represented by the following formulas (BisCZ), (BisB), (BisC), (BisZ), (BisCE), (BisA), (DHPE), (DPEC), (TPC), and (IPC) (also referred to below as compounds (BisCZ), (BisB), (BisC), (BisZ), (BisCE), (BisA), (DHPE), (DPEC), (TPC), and (IPC), respectively).

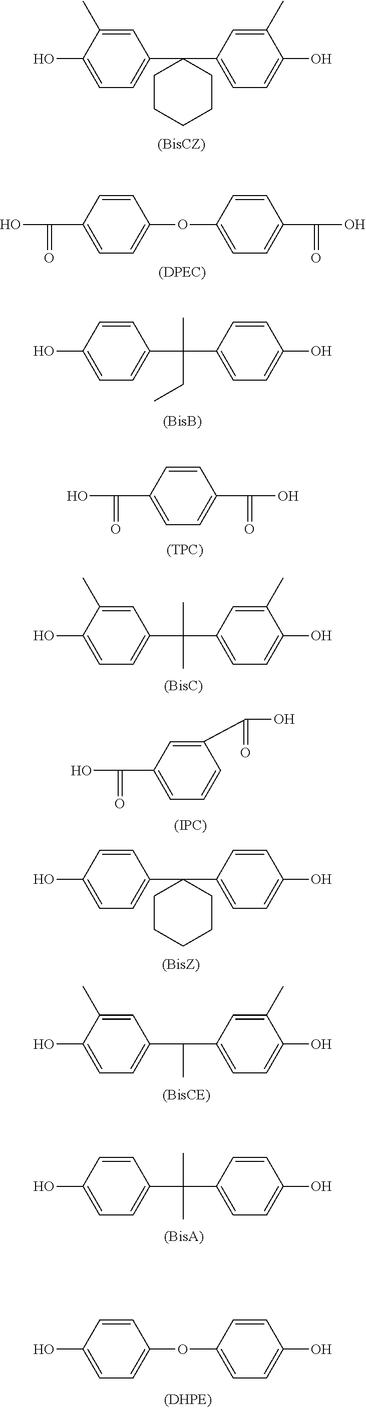

Also, the terms in Tables 3 and 4 mean as follows.
Monomer: monomers used for synthesis of corresponding polyarylate resin
Resin: polyarylate resin
Bisphenol addition rate: percentage (unit: %) of amount (unit: mol) of corresponding bisphenol monomer added to total amount (unit: mol) of bisphenol monomers added in synthesis of corresponding polyarylate resin
Dicarboxylic acid addition rate: percentage (unit: %) of amount (unit: mol) of corresponding dicarboxylic acid monomer added to total amount (unit: mol) of dicarboxylic acid monomers added in synthesis of corresponding polyarylate resin
Unit: repeating unit. Note that the repeating units listed in Tables 3 and 4 are formed from corresponding monomers listed in Tables 3 and 4.
DMP: 2,6-dimethylphenol
PFH: 1H,1H-perfluoro-1-heptanol
Molecular weight: viscosity average molecular weight
-: non-use of corresponding monomer
Unmeasurable: viscosity average molecular weight being not measured due to corresponding resin not dissolving in solvent for viscosity average molecular weight measurement

### <Synthesis of Resin (R-1)>

A three-neck flask equipped with a thermometer, a three-way cock, and a dropping funnel was used as a reaction vessel. The reaction vessel was charged with the compound (BisCZ) (32.8 mmol) being a monomer, the compound (DHPE) (8.2 mmol) being a monomer, 2,6-dimethylphenol (0.413 mmol) being a terminator, sodium hydroxide (98 mmol), and benzyltributylammonium chloride (0.384 mol). The air inside the reaction vessel was replaced with an argon gas. Water (300 mL) was added to the contents of the reaction vessel. The contents of the reaction vessel were stirred at 50° C. for 1 hour. The contents of the reaction vessel were cooled to 10° C. to yield an alkaline aqueous solution S-A.

Next, dicarboxylic acid dichloride (20.8 mmol) of the compound (DPEC) being a monomer and dicarboxylic acid dichloride (11.2 mmol) of the compound (TPC) being a monomer were dissolved in chloroform (150 mL). Thus, a chloroform solution S-B was yielded.

The chloroform solution S-B was slowly dripped into the alkaline aqueous solution S-A over 110 minutes using a dropping funnel. While the temperature (liquid temperature) of the contents of the reaction vessel was adjusted to 15±5° C., the contents of the reaction vessel were stirred for 4 hours to allow a polymerization reaction to proceed. Using a decant, the upper layer (water layer) of the contents of the reaction vessel was removed to obtain an organic layer. Next, ion exchange water (400 mL) was added into a conical flask. The resultant organic layer was further added into the conical flask. Chloroform (400 mL) and acetic acid (2 mL) were further added into the conical flask. The contents of the conical flask were stirred at room temperature (25° C.) for 30 minutes. Using a decant, the upper layer (water layer) of the contents of the conical flask was removed to obtain an organic layer. The resultant organic layer was washed with ion exchange water (1 L) using a separatory funnel. The washing with ion exchange water was repeated 5 times to obtain a water-washed organic layer. Next, the water-washed organic layer was filtered to obtain a filtrate. The resultant filtrate was slowly dripped into methanol (1 L) to obtain precipitate. The precipitate was taken out by filtering. The taken precipitated was vacuum dried at a temperature of 70° C. for 12 hours. Thus, a resin (R-1) was obtained.

### <Synthesis of Resins (R-2) to (R-7) and (R-D) to (R-S)>

Resins (R-2) to (R-7) and (R-D) to (R-S) were synthesized according to the same method as that for synthesizing the resin (R-1) in all aspects other than that the monomers shown in Tables 3 and 4 were used at the respective addition rates shown in Tables 3 and 4. Note that the amount of each bisphenol monomer added was set so as to achieve the corresponding bisphenol addition rate shown in Tables 3 and 4 and so that the total amount of the bisphenol monomers was 41.0 mmol. For example, in the synthesis of the resin (R-5), the amount of the compound (BisB) added was 32.8 mmol (=41.0×80/100) and the amount of the compound (DHPE) added was 8.2 mmol (=41.0×20/100). Furthermore, the amount of each dicarboxylic acid monomer was set so as to achieve the corresponding dicarboxylic acid addition rate shown in Tables 3 and 4 and so that the total amount of the dicarboxylic acid monomers was 32.0 mmol. For example, in the synthesis of the resin (R-5), the amount of the compound (DPEC) added was 16.0 mmol (=32.0×50/100) and the amount of the compound (TPC) added was 16.0 mmol (=32.0×50/100).

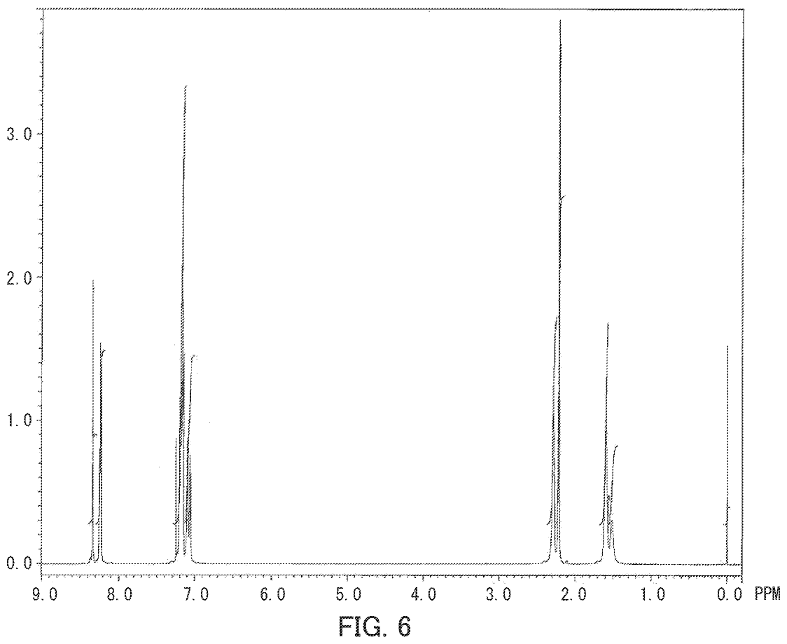

Using a proton nuclear magnetic resonance spectrometer (product of JEOL Ltd., 600 MHz), a ¹H-NMR spectrum of each of the resultant resins (R-1) to (R-7) and (R-D) to (R-S) was plotted. Deuterated chloroform was used as a solvent. Tetramethylsilane (TMS) was used as an internal standard sample. FIG. 6 shows the ¹H-NMR spectrum of the resin (R-1) as atypical example of the resins (R-1) to (R-7) and (R-D) to (R-S). It was confirmed from the chemical shift read from the ¹H-NMR spectrum that the resin (R-1) had been obtained. It was also confirmed according to the same method that the resins (R-2) to (R-7) and (R-D) to (R-S) had been obtained.

### [Polycarbonate Resins (R-A) and (R-B)]

Polycarbonate resins represented by formulas (R-A) and (R-B) were prepared each as a binder resin used for production of photosensitive members of comparative examples. In the following, the “polycarbonate resins represented by formulas (R-A) and (R-B)” may be also referred to below as “resins (R-A) and (R-B)”, respectively. The viscosity average molecular weights of the resins (R-A) and (R-B) were 65,000 and 58,000, respectively.

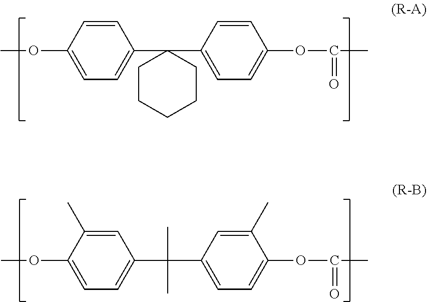

### [Measurement of Viscosity Average Molecular Weight]

The viscosity average molecular weight of each of the resins was measured in accordance with the Japanese Industrial Standards (JIS) K7252-1:2016. The measured viscosity average molecular weights are shown above in Tables 3 and 4.

### [Photosensitive Member Production]

Photosensitive members (A-1) to (A-28) and (B-1) to (B-22) were produced by the following methods. The constituents of these photosensitive members are shown in Tables 5 and 6 described later.

### <Production of Photosensitive Member (A-1)>

Using a rod-shaped sonic oscillator, 2.0 parts by mass of V-form titanyl phthalocyanine being a charge generating material, 70.0 parts by mass of the hole transport material (H-1), 50.0 parts by mass of the electron transport material (E-1), 100.0 parts by mass of the resin (R-1) being a binder resin, 10.0 parts by mass of the additive (ADD-2), and 500.0 parts by mass of tetrahydrofuran being a solvent were mixed for 20 minutes to obtain a dispersion. The dispersion was filtered using a filter with an opening of 5 μm to obtain an application liquid for photosensitive layer formation. The application liquid for photosensitive layer formation was applied onto a conductive substrate (drum-shaped aluminum support) by dip coating, and dried with hot air at 120° C. for 50 minutes. In the manner described above, a photosensitive layer (film thickness 30 μm) was formed on the conductive substrate. Thus, a photosensitive member (A-1) was obtained. In the photosensitive member (A-1), a single-layer photosensitive layer was directly provided on the conductive substrate. The content of the electron transport material relative to the mass of the photosensitive layer of the photosensitive member (A-1) is calculated to be 21.6% by mass using formula: “(Content of electron transport material)=100×(Mass of electron transport material)/[(Mass of charge generating material)+(Mass of hole transport material)+(Mass of electron transport material)+(Mass of binder resin)+(Mass of specified additive)]=100×50.0/(2.0+70.0+50.0+100.0+10.0)”.

### <Production of Photosensitive Members (A-2) to (A-28) and (B-1) to (B-22)>

Photosensitive members (A-2) to (A-28) and (B-1) to (B-22) were produced according to the same method as that for producing photosensitive member (A-1) in all aspects other than the following changes. The electron transport materials, the hole transport materials, the binder resins, and the specific additives shown in Tables 5 and 6 were used. Furthermore, the amount of the charge transport material added was changed to amounts that made the percentage contents of the electron transport material relative to the mass of the corresponding photosensitive layers those shown in Tables 5 and 6.

### [Evaluation]

With respect to each of the photosensitive members (A-1) to (A-28) and (B-1) to (B-22), abrasion resistance, filming resistance, scratch resistance and transfer memory inhibition were evaluated by the following methods. Evaluation results are shown in Tables 5 and 6 described later.

### <Evaluation Apparatus>

As an evaluation apparatus, a modified version of an image forming apparatus (“FS-C5250DN”, product of KYOCERA Document Solutions Japan Inc.) was used. The evaluation apparatus included as a charger a charging roller constituted by epichlorohydrin resin in which conductive carbon is dispersed. The charge polarity of the charging roller was positive and the application voltage of the charging roller was a direct current voltage. The evaluation apparatus adopted the two-component development system and the intermediate transfer process. The evaluation apparatus included a cleaning blade and a static eliminator. Furthermore, copy paper (“MULTIPAPER SUPER ECONOMY+”, product of ASKUL Corporation”) was used as paper for each evaluation.

### <Abrasion Resistance>

Abrasion resistance was evaluated in an environment at a temperature of 23° C. and a relative humidity of 50%. A film thickness T1 of the photosensitive layer of the photosensitive member was measured. The photosensitive member was then mounted in the evaluation apparatus. An image 1 (a character image with a printing rate of 5%) was consecutively printed on 100,000 sheets of paper using the evaluation apparatus. After the printing, a film thickness T2 of the photosensitive layer of the photosensitive member was measured. Note that an eddy-current coating thickness tester (“LH-373”, product of Kett Electric Laboratory Co. Ltd.) was used to measure the film thicknesses T1 and T2. The amount (unit: μm) of abrasion on the photosensitive layer was calculated using formula “Amount of abrasion=T1−T2”. The smaller the amount of abrasion, the better the abrasion resistance of the photosensitive member.

### <Filming Resistance and Scratch Resistance>

The photosensitive member was mounted in the evaluation apparatus. The image 1 (a character image with a printing rate of 5%) was consecutively printed on 100,000 sheets of paper using the evaluation apparatus in an environment at a temperature of 23° C. and a relative humidity of 50%. Next, an image II (including a halftone image and a blank background image) was printed on a sheet of paper using the evaluation apparatus, and the resulting image was taken as a first evaluation image.

After obtaining the first evaluation image, the photosensitive member was taken out of the evaluation apparatus. The surface of the photosensitive member was observed with the naked eye to confirm the presence or absence of scratches and filming on the surface of the photosensitive member. After the visual observation, the photosensitive member was mounted in the evaluation apparatus again.

Thereafter, the image 1 (a character image with a printing rate of 5%) was consecutively printed on 50,000 sheets of paper using the evaluation apparatus in an environment of a temperature of 10° C. and a relative humidity of 15%. Next, the image II (including a halftone image and a blank background image) was printed on a sheet of paper using the evaluation apparatus, and the resulting image was taken as the second evaluation image.

The first evaluation image and the second evaluation image were observed to confirm the presence or absence of image defects due to filming or scratches on the surface of the photosensitive member. Examples of the image defects resulting from filming includes dash marks, fogging, and streaks. Dash marks are black dots arranged parallel to the paper conveyance direction. The larger the area where filming occurs on the surface of the photosensitive member, the more fogging starting from the dash marks will occur in the formed image. The streaks are black lines parallel to the paper conveyance direction. Examples of the image defects resulting from scratches include white streaks and black streaks. Based on the inspection results on the surface of the photosensitive member and the assessment of image defects in the first and second evaluation images, filming resistance and scratch resistance were evaluated according to the following criteria.

### (Criteria of Filming Resistance and Scratch Resistance)

A (very good): Neither scratches nor filming occurred on the surface of the photosensitive member, and no image defects occurred in both the first evaluation image and the second evaluation image.
B (good): Although at least one of scratches and filming occurred on the surface of the photosensitive member, no image defects occurred in both the first evaluation image and the second evaluation image.
C (Poor): Either scratches or filming occurred on the surface of the photosensitive member. Image defects occurred in the second evaluation image, but no image defects occurred in the first evaluation image.
D (very poor): Either scratches or filming occurred on the surface of the photosensitive member, and image defects occurred in both the first evaluation image and the second evaluation image.

### <Transfer Memory Inhibition>

The evaluation of transfer memory inhibition was conducted in an environment at a temperature of 23° C. and a relative humidity of 50%. The application voltage of the charging roller was set so that the charge potential of the photosensitive member was +570 V. The exposure light of the light exposure device was set to have a wavelength of 780 nm, a half-width of 20 nm, and a light intensity of 1.16 μJ/m². The transfer bias of the primary transfer roller was set to −2.0 kV.

The photosensitive member was charged and exposed to light using the evaluation apparatus. The surface potential of the non-exposed area (corresponding to the blank area) was measured at the development position. The measured surface potential of the non-exposed area was taken as a pre-transfer non-exposed area potential V₃ (unit: +V).

Next, a transfer bias was applied to the photosensitive member. Next, the photosensitive member was subjected to removal of static electricity and charged again, and the surface potential of the non-exposed area (corresponding to the blank area) was measured at the development position. The measured surface potential of the non-exposed area was taken as a post-transfer non-exposed area potential V₄ (unit: +V).

A transfer memory potential ΔVtc (unit: V) was calculated using the calculation formula “ΔVtc=V₃−V₄”. A smaller ΔVtc indicates further inhibition of transfer memory.

The terms in Tables 5 to 6 mean as follows. “E” means an example, and “C” means a comparative example. “ETM” means electron transport material. “Percentage content” means the percentage content of the electron transport material to the mass of a corresponding photosensitive layer. “wt %” means percentage by mass. “HTM” means hole transport material. “Resin” means binder resin. “Additive” means specific additive. “Abrasion” means the amount of abrasion of a corresponding photosensitive member measured in the evaluation of abrasion resistance. “Filming/Scratch” means the evaluation results of filming resistance and scratch resistance. “ΔVtc” means the transfer memory potential measured in the evaluation of transfer memory inhibition.

TABLE 5

| | | ETM | | | | | | | |
|---|---|---|---|---|---|---|---|---|---|
| | | | Per- | | | | | | |
| | Pho- | | cent- | | | | | | |
| | to- | | age | | | | | | |
| | sensi- | | con- | | | | A- | | |
| | tive | | tent | | | | bra- | Film- | |
| | mem- | | (wt | | Re- | Ad- | sion | ing/ | ΔVtc |
| | ber | type | %) | HTM | sin | ditive | (μm) | Scratch | (V) |
| E1 | A-1 | E-1 | 21.6 | H-1 | R-1 | ADD-2 | 0.82 | A | 23 |
| E2 | A-2 | E-1 | 21.6 | H-1 | R-2 | ADD-2 | 1.04 | B | 36 |
| E3 | A-3 | E-1 | 21.6 | H-1 | R-3 | ADD-2 | 0.92 | A | 28 |
| E4 | A-4 | E-1 | 21.6 | H-1 | R-4 | ADD-2 | 0.99 | A | 30 |
| E5 | A-5 | E-1 | 21.6 | H-1 | R-5 | ADD-2 | 1.02 | B | 33 |
| E6 | A-6 | E-1 | 21.6 | H-1 | R-6 | ADD-2 | 0.95 | A | 29 |
| E7 | A-7 | E-1 | 21.6 | H-1 | R-7 | ADD-2 | 0.79 | A | 28 |
| E8 | A-8 | E-1 | 16.1 | H-1 | R-1 | ADD-2 | 0.80 | A | 37 |
| E9 | A-9 | E-1 | 26.3 | H-1 | R-1 | ADD-2 | 0.92 | A | 23 |
| E10 | A-10 | E-1 | 30.5 | H-1 | R-I | ADD-2 | 1.15 | B | 19 |
| E11 | A-11 | E-2 | 21.6 | H-1 | R-1 | ADD-2 | 0.85 | A | 25 |
| E12 | A-12 | E-3 | 21.6 | H-1 | R-1 | ADD-2 | 0.86 | A | 29 |
| E13 | A-13 | E-4 | 21.6 | H-1 | R-1 | ADD-2 | 0.86 | A | 33 |
| E14 | A-14 | E-5 | 21.6 | H-1 | R-1 | ADD-2 | 0.86 | A | 27 |
| E15 | A-15 | E-5 | 16.1 | H-1 | R-1 | ADD-2 | 0.82 | A | 36 |
| E16 | A-16 | E-5 | 26.3 | H-1 | R-1 | ADD-2 | 0.90 | A | 24 |
| E17 | A-17 | E-5 | 30.5 | H-1 | R-1 | ADD-2 | 1.09 | B | 20 |
| E18 | A-18 | E-6 | 21.6 | H-1 | R-1 | ADD-2 | 0.88 | A | 36 |
| E19 | A-19 | E-7 | 21.6 | H-1 | R-1 | ADD-2 | 0.90 | A | 39 |
| E20 | A-20 | E-8 | 21.6 | H-1 | R-1 | ADD-2 | 0.85 | A | 25 |
| E21 | A-21 | E-1 | 21.6 | H-2 | R-1 | ADD-2 | 0.84 | A | 26 |
| E22 | A-22 | E-1 | 21.6 | H-3 | R-1 | ADD-2 | 0.85 | A | 22 |
| E23 | A-23 | E-1 | 21.6 | H-4 | R-1 | ADD-2 | 0.85 | A | 22 |
| E24 | A-24 | E-1 | 21.6 | H-5 | R-1 | ADD-2 | 0.88 | A | 25 |
| E25 | A-25 | E-1 | 21.6 | H-6 | R-1 | ADD-2 | 0.88 | A | 23 |
| E26 | A-26 | E-1 | 21.6 | H-7 | R-1 | ADD-2 | 0.83 | A | 25 |
| E27 | A-27 | E-1 | 21.6 | H-8 | R-1 | ADD-2 | 0.82 | A | 24 |
| E28 | A-28 | E-1 | 21.6 | H-1 | R-1 | ADD-1 | 0.85 | A | 30 |

TABLE 6

| | | ETM | | | | | | | |
|---|---|---|---|---|---|---|---|---|---|
| | | | Per- | | | | | | |
| | Pho- | | cent- | | | | | | |
| | to- | | age | | | | | | |
| | sensi- | | con- | | | | A- | | |
| | tive | | tent | | | | bra- | Film- | |
| | mem- | | (wt | | Re- | Ad- | sion | ing/ | ΔVtc |
| | ber | Type | %) | HTM | sin | ditive | (μm) | Scratch | (V) |
| C1 | B-1 | E-1 | 21.6 | H-1 | R-A | ADD-2 | 5.21 | D | 89 |
| C2 | B-2 | E-1 | 21.6 | H-1 | R-B | ADD-2 | 5.82 | D | 102 |
| C3 | B-3 | E-1 | 21.6 | H-1 | R-D | ADD-2 | 5.65 | D | 95 |
| C4 | B-4 | E-1 | 21.6 | H-1 | R-E | ADD-2 | 5.63 | D | 93 |
| C5 | B-5 | E-1 | 21.6 | H-1 | R-F | ADD-2 | 3.23 | D | 98 |
| C6 | B-6 | E-1 | 21.6 | H-1 | R-G | ADD-2 | 2.02 | C | 78 |
| C7 | B-7 | E-1 | 21.6 | H-1 | R-H | ADD-2 | 2.32 | C | 82 |
| C8 | B-8 | E-1 | 21.6 | H-1 | R-I | ADD-2 | 2.17 | C | 73 |
| C9 | B-9 | E-1 | 21.6 | H-1 | R-J | ADD-2 | 2.56 | D | 94 |
| C10 | B-10 | E-1 | 21.6 | H-1 | R-K | ADD-2 | 2.37 | D | 99 |
| C11 | B-11 | E-1 | 21.6 | H-1 | R-L | ADD-2 | 2.43 | D | 105 |
| C12 | B-12 | E-1 | 21.6 | H-1 | R-M | ADD-2 | 3.56 | D | 103 |
| C13 | B-13 | E-1 | 21.6 | H-1 | R-N | ADD-2 | 2.24 | C | 92 |
| C14 | B-14 | E-1 | 21.6 | H-1 | R-O | ADD-2 | 2.34 | C | 88 |
| C15 | B-15 | E-1 | 21.6 | H-1 | R-P | ADD-2 | 2.65 | D | 108 |
| C16 | B-16 | E-1 | 21.6 | H-1 | R-Q | ADD-2 | 2.76 | C | 73 |
| C17 | B-17 | B-1 | 21.6 | H-1 | R-R | ADD-2 | 2.63 | D | 104 |
| C18 | B-18 | E-1 | 21.6 | H-1 | R-S | ADD-2 | 2.21 | C | 84 |
| C19 | B-19 | E-1 | 14.2 | H-1 | R-F | ADD-2 | 3.25 | D | 118 |
| C20 | B-20 | E-1 | 34.3 | H-1 | R-F | ADD-2 | 4.32 | D | 79 |
| C21 | B-21 | E-5 | 14.2 | H-1 | R-F | ADD-2 | 3.34 | D | 114 |
| C22 | B-22 | E-5 | 34.3 | H-1 | R-F | ADD-2 | 4.25 | D | 74 |

As shown in Table 6, the photosensitive layers of photosensitive members (B-1) to (B-22) each contained any of the resins (R-A) to (R-B) and (R-D) to (R-S). However, these resins are not the polyarylate resins (PA). Furthermore, the contents of the electron transport material in the photosensitive members (B-19) and (B-21) were less than 15% by mass to the mass of the photosensitive layer. The amounts of abrasion of photosensitive members (B-1) to (B-22) as large as 2.02 μm or more. The photosensitive members (B-1) to (B-22) each were rated as poor or very poor in evaluation of filming resistance and scratch resistance. The transfer memory potentials of the photosensitive members (B-1) to (B-22) as high as 73V or more.

By contrast, as shown in Table 5, the photosensitive layers of the photosensitive members (A-1) to (A-28) each contained a charge generating material, a binder resin, an electron transport material, and a hole transport material. The binder resin contained the polyarylate resin (PA) (specifically, any of the resins (R-1) to (R-7)). The electron transport material contained any of electron transport materials (11) to (17) (specifically, any of electron transport materials (E-1) to (E-8)). The hole transport material contained any of the hole transport materials (20) to (22) (specifically, any of the hole transport materials (H-1) to (H-8)). The percentage content of the electron transport material was at least 15% by mass and no greater than 35% by mass to the mass of the photosensitive layer. The amounts of abrasion of the photosensitive members (A-1) to (A-28) were as small as 1.15 μm or less. The photosensitive members (A-1) to (A-28) were rated as good or very good in the valuation of the filming resistance and scratch resistance. The transfer memory potentials of the photosensitive members (A-1) to (A-28) were as low as 39V or less.

The above indicates that the photosensitive member of the present disclosure, encompassing the photosensitive members (A-1) to (A-28), have excellent abrasion resistance, filming resistance, and scratch resistance, and can inhibit transfer memory. It is considered that the process cartridge and image forming apparatus of the present disclosure including such a photosensitive member have excellent abrasion resistance, filming resistance, and scratch resistance, and can inhibit transfer memory.

What is claimed is:

1. An electrophotographic photosensitive member comprising:
a conductive substrate; and
a photosensitive layer, wherein
the photosensitive layer is a single layer,
the photosensitive layer contains a charge generating material, a binder resin, an electron transport material, and a hole transport material,
the binder resin includes a polyarylate resin,
the polyarylate resin includes repeating units represented by formula (1), (2), (3), and (4),
the repeating unit represented by the formula (3) has a percentage content of greater than 0% and less than 50% to a total number of repeats of the repeating units represented by the formulas (1) and (3),
the repeating unit represented by the formula (4) has a percentage content of at least 35% and less than 70% to a total number of repeats of the repeating units represented by the formulas (2) and (4),
the electron transport material includes a compound represented by formula (11), (12), (13), (14), (15), (16) or (17),
the hole transport material includes a compound represented by formula (20), (21), or (22), and
the electron transport material has a percentage content of at least 15% by mass and no greater than 35% by mass to the mass of the photosensitive layer: 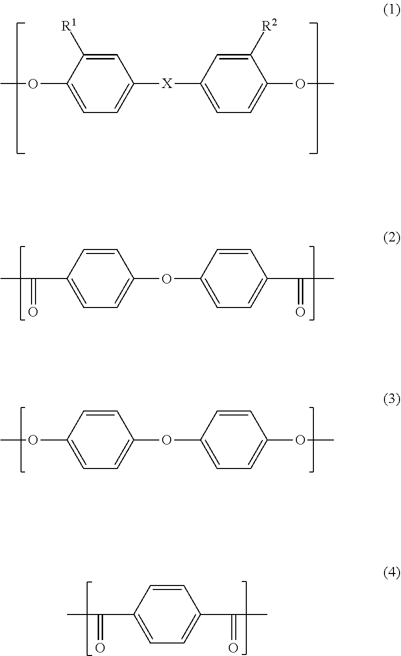
where in the formula (1),
R¹ and R² each represent a methyl group and X represents a divalent group represented by formula (X1), or
R¹ and R² each represent a hydrogen atom and X represents a divalent group represented by formula (X2), 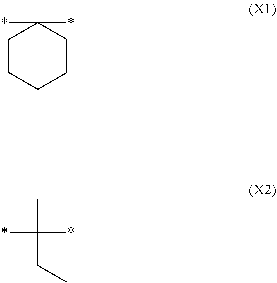
in the formulas (X1) and (X2), * represents a bond, 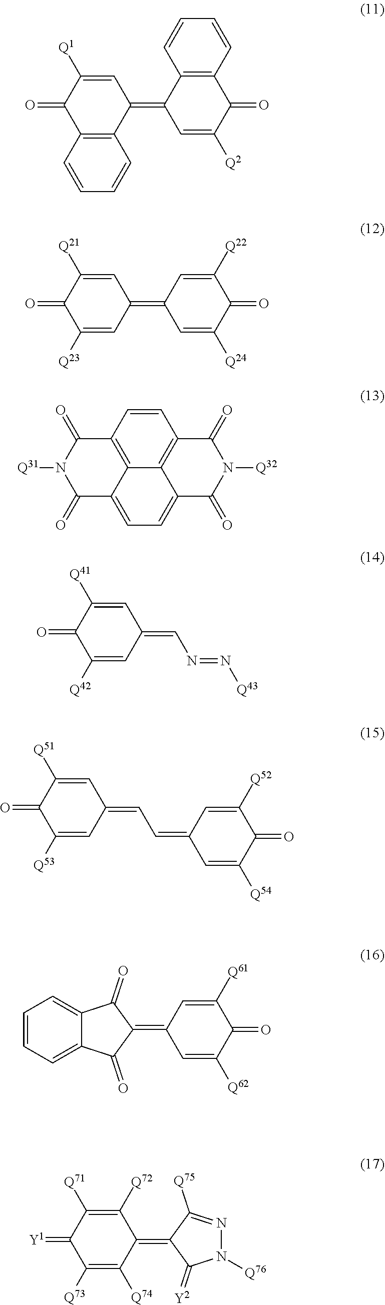
Q¹ and Q² in the formula (11), Q²¹, Q²², Q²³, and Q²⁴ in the formula (12), Q³¹ and Q³² in the formula (13), Q⁴¹, Q⁴², and Q⁴³ in the formula (14), Q⁵¹, Q⁵², Q⁵³, and Q⁵⁴ in the formula (15), Q⁶¹ and Q⁶² in the formula (16), and Q⁷¹, Q⁷², Q⁷³, Q⁷⁴, Q⁷⁵, and Q⁷⁶ in the formula (17) each represent, independently of one another, a hydrogen atom, a halogen atom, a cyano group, an alkyl group with a carbon number of at least 1 and no greater than 6, an alkenyl group with a carbon number of at least 2 and no greater than 6, an alkoxy group with a carbon number of at least 1 and no greater than 6, or an aryl group with a carbon number of at least 6 and no greater than 14 optionally substituted with at least one substituent selected from the group consisting of a halogen atom and an alkyl group with a carbon number of at least 1 and no greater than 6, and
in the formula (17), Y¹ and Y² each represent, independently of one another, an oxygen atom or a sulfur atom, 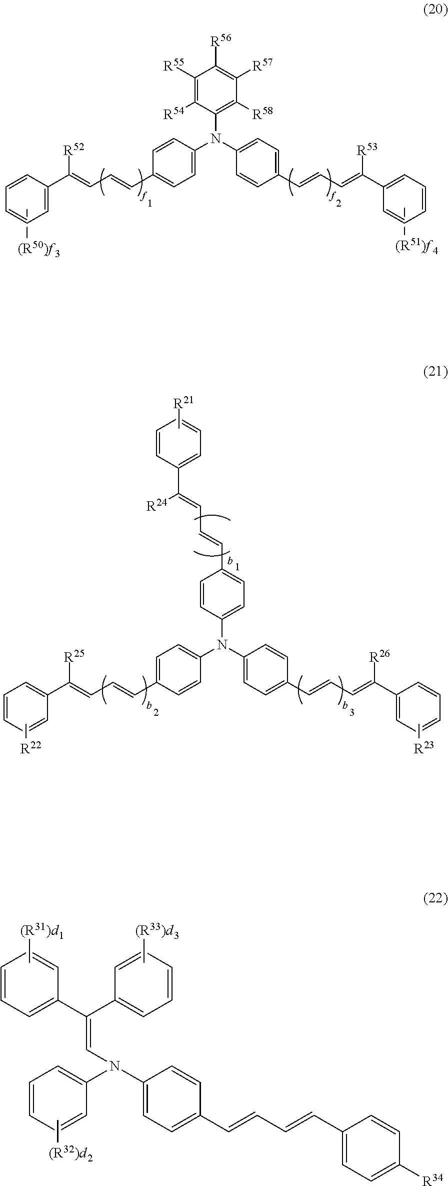
in the formula (20), R⁵⁰ and R⁵¹ each represent, independently of one another, a phenyl group, an alkyl group with carbon number of at least 1 and no greater than 6, or an alkoxy group with carbon number of at least 1 and no greater than 6; R⁵², R⁵³, R⁵⁴, R⁵⁵, R⁵⁶, R⁵⁷, and R⁵⁸ each represent, independently of one another, a hydrogen atom, an alkyl group with carbon number of at least 1 and no greater than 6, an alkoxy group with carbon number of at least 1 and no greater than 6, or a phenyl group optionally substituted with an alkyl group with carbon number of at least 1 and no greater than 6; f₁ and f₂ each represent, independently of one another, an integer of at least 0 and no greater than 2; and f₃ and f₄ each represent, independently of one another, an integer of at least 0 and no greater than 5,
in the formula (21), R²¹, R²², and R²³ each represent, independently of one another, an alkyl group with carbon number of at least 1 and no greater than 6; R²⁴, R²⁵, and R²⁶ each represent, independently of one another, a hydrogen atom or an alkyl group with carbon number of at least 1 and no greater than 6; and b₁, b₂, and b₃ each represent, independently of one another, 0 or 1, and
in the formula (22), R³¹, R³², and R³³ each represent, independently of one another, an alkyl group with carbon number of at least 1 and no greater than 6, and R³⁴ represents a hydrogen atom or an alkyl group with carbon number of at least 1 and no greater than 6; and d₁, d₂, and d₃ each represent, independently of one another, an integer of at least 0 and no greater than 5.

2. The electrophotographic photosensitive member according to claim 1, wherein the polyarylate resin does not include a repeating unit represented by formula (5):

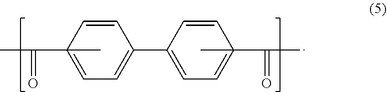

3. The electrophotographic photosensitive member according to claim 1, wherein the charge generating material includes titanyl phthalocyanine.

4. The electrophotographic photosensitive member according to claim 1, wherein
the photosensitive layer further contains a compound represented by formula (30) or (31): 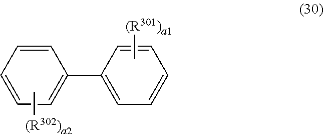
where in the formula (30),
R³⁰¹ and R³⁰² each represent, independently of one another, a nitro group, an aryl group with a carbon number of at least 6 and no greater than 14, or an alkyl group with a carbon number of at least 1 and no greater than 6 optionally substituted with an aryl group with a carbon number of at least 6 and no greater than 14, and
a1 and a2 each represent, independently of one another, an integer of at least 0 and no greater than 5, and 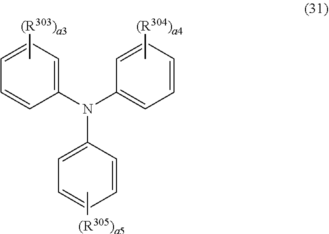
where in the formula (31),
R³⁰³, R³⁰⁴, and R³⁰⁵ each represent, independently of one another, an alkyl group with a carbon number of at least 1 and no greater than 6 or an alkoxy group with a carbon number of at least 1 and no greater than 6, and
a3, a4, and a5 each represent, independently of one another, an integer of at least 0 and no greater than 5.

5. A process cartridge comprising:
at least one selected from the group consisting of a charger, a light exposure device, a development device, a transfer device, a cleaner, and a static eliminator; and
the electrophotographic photosensitive member according to claim 1.

6. An image forming apparatus comprising:
an image bearing member;
a charger that charges a surface of the image bearing member;
a light exposure device that exposes the charged surface of the image bearing member with light to form an electrostatic latent image on the surface of the image bearing member;
a development device that develops the electrostatic latent image into a toner image by supplying a toner to the surface of the image bearing member; and
a transfer device that transfers the toner image from the image bearing member to a transfer target, wherein
the image bearing member is the electrophotographic photosensitive member according to claim 1.

7. The image forming apparatus according to claim 8, further comprising either or both
a cleaner that collects toner of the toner attached to the surface of the image bearing member; and
a static eliminator that removes static electricity on the surface of the image bearing member.

8. The image forming apparatus according to claim 6, wherein
the charger is a charging roller.

9. The image forming apparatus according to claim 8, wherein
the development device supplies the toner to the surface of the image bearing member, the toner being charged by friction with a carrier.
